(19) United States
(12) Patent Application Publication
(10) Pub. No.: US 2026/0353344 A1
(43) Pub. Date: Nov. 5, 2026

(54) METHOD FOR SUPPORTING TRANSMISSION OF A REFERENCE SIGNAL FOR POSITIONING IN ONE OR MORE UNLICENSED FREQUENCY BANDS, A RELATED TRANSMITTER NODE, A RELATED RECEIVER NODE, AND A RELATED RESOURCE ALLOCATION NODE

(71) Applicant: Sony Group Corporation, Tokyo (JP)

(72) Inventors: Basuki PRIYANTO, Lund (SE); Naoki KUSASHIMA, Basingstoke (GB); Jose FLORDELIS, Lund (SE); Yujie ZHANG, Lund (SE); Anders BERGGREN, Lund (SE)

(21) Appl. No.: 19/487,439

(22) PCT Filed: May 29, 2024
(86) PCT No.: PCT/EP2024/064764

§ 371 Date: Nov. 24, 2025

(30) Foreign Application Priority Data
Jun. 7, 2023 (SE) 2350691-8

(51) Int. Cl. H04W 64/00; H04L 5/00; H04W 72/0453

(52) U.S. Cl. CPC H04W 64/00; H04L 5/0048; H04W 72/0453

(57) ABSTRACT

Disclosed is a method, performed by a transmitter node, for supporting transmission of a reference signal for positioning in one or more unlicensed frequency bands. The method comprises obtaining a resource configuration indicative of a set of allocated resources comprising a first number of frequency channels. The method comprises initiating a transmission of the reference signal using a set of required resources, wherein the set of required resources is a subset of the set of allocated resources.

The present disclosure pertains to the field of wireless communications. The present disclosure relates to a method for supporting transmission of a reference signal for positioning in one or more unlicensed frequency bands, a related transmitter node, and a related receiver node.

### BACKGROUND

Transmission of a wideband reference signal for positioning is expected to improve positioning accuracy in radio-access technology (RAT) dependent positioning systems. Wideband positioning reference signal transmission can improve positioning estimation accuracy by providing more precise timing information, which may result in more accurate distance measurements. For example, a wideband transmission uses a signal with a larger bandwidth, such as wideband bandwidth, which results in a shorter signal duration. Such shorter duration leads to more precise timing measurements and may help to reduce errors in position estimation. The wideband bandwidth is typically available in unlicensed spectrum. However, the radio resource in unlicensed spectrum, such as a New Radio on unlicensed spectrum (NR-U) resource, may not be guaranteed to be used or be available by a transmitter node intending to perform a transmission as such NR-U resource may be shared with other transmission nodes and even with other communication systems (such as, Wi-Fi, Bluetooth, among others). Availability of NR-U resources to be used for transmission of a wideband reference signal for positioning is still an open issue, especially in NR unlicensed operation for both direct or Uu-link positioning and sidelink positioning (such as, PC5-link positioning).

### SUMMARY

Transmission of a signal in unlicensed spectrum is typically based on a Listen Before Talk (LBT) mechanism. Non-availability of radio resources in unlicensed spectrum, such as NR-U resources in 5G New Radio (NR) system, to be used for transmission of a wideband reference signal for positioning may lead to an LBT failure indicating that a transmitter node intending to perform a transmission is not allowed to use the NR-U resources for such.

Accordingly, there is a need for devices and methods for supporting transmission of a reference signal for positioning in one or more unlicensed frequency bands, which may mitigate, alleviate, or address the shortcomings existing and may provide for a reduction in the impact of LBT failure in order to maintain transmission of a reference signal for positioning from a transmitter node to a receiver node.

Disclosed is a method, performed by a transmitter node, for supporting transmission of a reference signal for positioning in one or more unlicensed frequency bands. The method comprises obtaining a resource configuration indicative of a set of allocated resources comprising a first number of frequency channels. The method comprises initiating a transmission of the reference signal using a set of required resources, wherein the set of required resources is a subset of the set of allocated resources.

Further, a transmitter node comprising memory circuitry, processor circuitry, and a wireless interface is provided. The transmitter node is configured to perform any of the methods disclosed herein.

It is an advantage of the present disclosure that the disclosed method enables mitigation or anticipation of LBT failures for an upcoming reference signal transmission by using resource configurations where a set of allocated resources provides additional resources in the frequency and/or time domain. The disclosed method provides accurate positioning of a node and/or an entity that needs to be positioned. The disclosed method allows the transmitter node either to be accurately positioned or to assist a node that needs to be positioned in achieving such positioning accuracy. The disclosed method enables mitigation or anticipation of LBT failures for an upcoming reference signal transmission by configuring additional resources and/or performing retransmissions of the reference signal using the set of allocated resources when such LBT failures happen. In other words, the disclosed method allows retransmissions of one or more parts of the reference signal that could not be transmitted due to such LBT failures.

Disclosed is a method, performed by a receiver node, for supporting reception of a reference signal for positioning in one or more unlicensed frequency bands. The method comprises obtaining a resource configuration indicative of a set of allocated resources comprising a first number of frequency channels. The method comprises initiating a reception of the reference signal using a set of required resources, wherein the set of required resources is a subset of the set of allocated resources.

Further, a receiver node comprising memory circuitry, processor circuitry, and a wireless interface is provided. The receiver node is configured to perform any of the methods disclosed herein.

It is an advantage of the present disclosure that the disclosed method enables mitigation or anticipation of LBT failures for an upcoming reference signal reception by using resource configurations where a set of allocated resources provide additional resources in the frequency and/or time domain. The disclosed method provides accurate positioning of a node and/or an entity that needs to be positioned. The disclosed method allows the receiver node either to be accurately positioned or to assist a node that needs to be positioned in achieving such positioning accuracy. The disclosed method enables mitigation or anticipation of LBT failures for an upcoming reference signal reception by configuring additional resources and/or performing retransmissions of the reference signal using the set of allocated resources when such LBT failures happen. In other words, the disclosed method allows retransmissions of one or more parts of the reference signal that could not be transmitted due to such LBT failures.

Disclosed is a method, performed by a resource allocation node, for supporting transmission and/or reception of a reference signal for positioning in one or more unlicensed frequency bands. The method comprises receiving, from a transmitter node, a third message indicative of a length of the reference signal. The method comprises determining, based on the third message, a resource configuration indicative of a set of allocated resources comprising a first number of frequency channels. A transmission of the reference signal requires a set of required resources. The set of required resources is a subset of the set of allocated resources. The method comprises providing the resource configuration.

Further, a resource allocation node comprising memory circuitry, processor circuitry, and a wireless interface is provided. The resource allocation node is configured to perform any of the methods disclosed herein.

It is an advantage of the present disclosure that the disclosed method and resource allocation node allow determination of resource configurations where a set of allocated resources provide additional resources in the frequency and/or time domain. Such resource configurations allow mitigation or anticipation of LBT failures for an upcoming reference signal transmission. The disclosed method and resource allocation node enable the transmitter node and/or the receiver node to be accurately positioning owing to determination of the resource configurations comprising additional resources in the frequency and/or time domain. The determination of the resource configurations comprising additional resources in the frequency and/or time domain can allow a transmitter device to be configured with the additional resources and/or retransmit the reference signal using the set of allocated resources, reducing the impact of an LBT failure when a transmission node transmits a reference signal.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node and example wireless devices according to this disclosure,

FIGS. 2A-2C illustrate an example scenario where a technique according to this disclosure is applied,

FIG. 3 illustrates an example scenario where a technique according to this disclosure is applied,

FIGS. 4A-4D illustrate an example scenario where a technique according to this disclosure is applied,

FIGS. 5A-5C is a flow-chart illustrating an example method, performed by a transmitter node, for supporting transmission of a reference signal for positioning in one or more unlicensed frequency bands according to this disclosure,

FIG. 6A-6C is a flow-chart illustrating an example method, performed by a receiver node, for supporting reception of a reference signal for positioning in one or more unlicensed frequency bands according to this disclosure,

FIG. 7 is a flow-chart illustrating an example method, performed by a resource allocation node, for supporting transmission and/or reception of a reference signal for positioning in one or more unlicensed frequency bands according to this disclosure,

FIG. 8 is a block diagram illustrating an example transmitter node according to this disclosure,

FIG. 9 is a block diagram illustrating an example receiver node according to this disclosure,

FIG. 10 is a block diagram illustrating an example resource allocation node according to this disclosure,

FIG. 11 is a signaling diagram illustrating an example communication between a network node and a wireless device according to this disclosure, and

FIG. 12 is a signaling diagram illustrating an example communication between a first wireless device and a second wireless device according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

NR positioning has been well established since 3GPP release-16, supporting various positioning techniques, such as downlink Time Difference of Arrival (DL-TDOA), Downlink Angle of Departure (DL-AoD), Uplink angle-of-arrival (UL-AoA), and/or Round-trip Time (RTT). Such positioning technique relies on reference signal transmission and positioning measurement at the receiver. The positioning measurement may be one or more of: a timing measurement (such as, TDOA and/or RTT), a received Signal Strength (RSS), a Reference Signal Received Power (RSRP), a Reference Signal Relative Path Power (RSRPP), and an angle measurement (such as, AoD and/or AoA).

An accurate positioning measurement may lead to an accurate positioning estimation. One option to improve quality of a positioning measurement may be to perform such measurement based on a wideband positioning reference signal transmission.

In an unlicensed frequency band, two or more communication systems may operate in the same frequency band, where their transmissions can interfere with each other, especially when different communications systems are used (such as, Wi-Fi, Bluetooth, LTE and NR). An LBT protocol is required by regulatory bodies for each node operating in an unlicensed frequency band to reduce interferences among different communication systems sharing that frequency band.

In an LBT procedure, a transmitter node that intends to transmit a signal (such as, a packet) may sense and/or monitor the frequency band for any energy levels above a threshold to determine if any other node or device is performing a transmission, such as to “listen”. Thus, the transmitter node may be required to determine an availability of the one or more channels, such as sub-channels, of the unlicensed frequency band. When there is no detected transmission, the transmitter node is then configured to transmit the signal on one or more channels of the unlicensed frequency band, such as to “talk”. On the contrary, when there is a detected transmission of another node on the frequency band, the transmitter node is configured to continue monitoring the frequency band until the transmitter node does not detect any other transmissions, and then transmit the signal at a later time. When the transmitter node detects that another node or device is transmitting on a channel of the frequency band, this may be seen as an LBT failure detected on that channel.

For example, an LBT procedure may be performed during a Clear Channel Assessment (CCA) phase by a transmitter node that intends to perform a transmission of a signal using one or more channels of a certain frequency band. When no other transmission by another node or device is detected by the transmitter node (such as, an energy level below a threshold) after the CCA phase, the transmitter node moves into a Channel Occupancy Time (COT) phase where the transmitter node can transmit the signal. A COT may be seen as a total time during which a transmitter node and a receiver node sharing the channel occupancy perform transmissions on a certain channel.

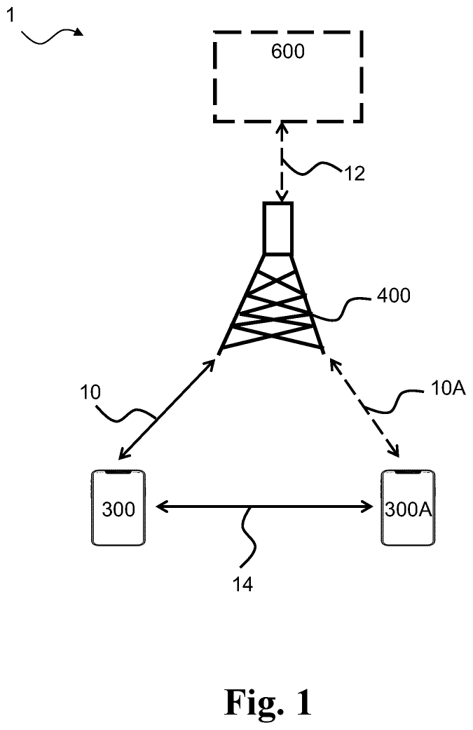

FIG. 1 is a diagram illustrating an example wireless communication system 1 comprising an example network node 400 and example wireless devices 300, 300A according to this disclosure.

As discussed in detail herein, the present disclosure relates to a wireless communication system 1 comprising a cellular system, for example, a 3GPP wireless communication system. The wireless communication system 1 comprises one or more of: one or more wireless devices 300, 300A, one or more network nodes 400, and a core network (CN) node 600.

A network node disclosed herein refers to a radio access network (RAN) node operating in the radio access network, such as one or more of: a base station (BS), an evolved Node B (eNB), a next generation Node B (gNB) in New Radio (NR), other new name that could be introduced in 6G RAN, an access point (AP), and a small cell (SC). In one or more examples, the RAN node is a functional unit which may be distributed in several physical units.

A CN node disclosed herein refers to a network node operating in the core network, such as in one or more of: an Evolved Packet Core (EPC) Network, a 5G Core (5GC) Network, and a 6G Core (6GC) Network. Examples of CN nodes in EPC Network include a Mobility Management Entity (MME), a Location Management Function (LMF), and an Access and Mobility Management Function (AMF). In one or more examples, a CN node can be seen as a resource allocation node.

A wireless device may refer to one or more of: a mobile device and a user equipment, UE.

The wireless device 300, 300A may be configured to communicate with the network node 400 via a wireless link (or radio access link) 10, 10A. The wireless device 300 may be seen as a first wireless device, such as a first wireless device as disclosed herein.

The radio network node 400 may be configured to communicate with the CN node 600 via a wired or wireless link 12.

The wireless device 300 may be configured to communicate with the wireless device 300A via a wireless link (or radio access link) 14. The wireless device 300A may be seen as a second wireless device, such as a second wireless device as disclosed herein.

The present disclosure may involve transmission, from a transmitter node to a receiver node, of a reference signal for positioning in one or more unlicensed frequency bands. The present disclosure may involve one or more of: a downlink (DL)-based positioning procedure, an uplink (UL)-based positioning procedure, and a sidelink (SL)-based positioning procedure.

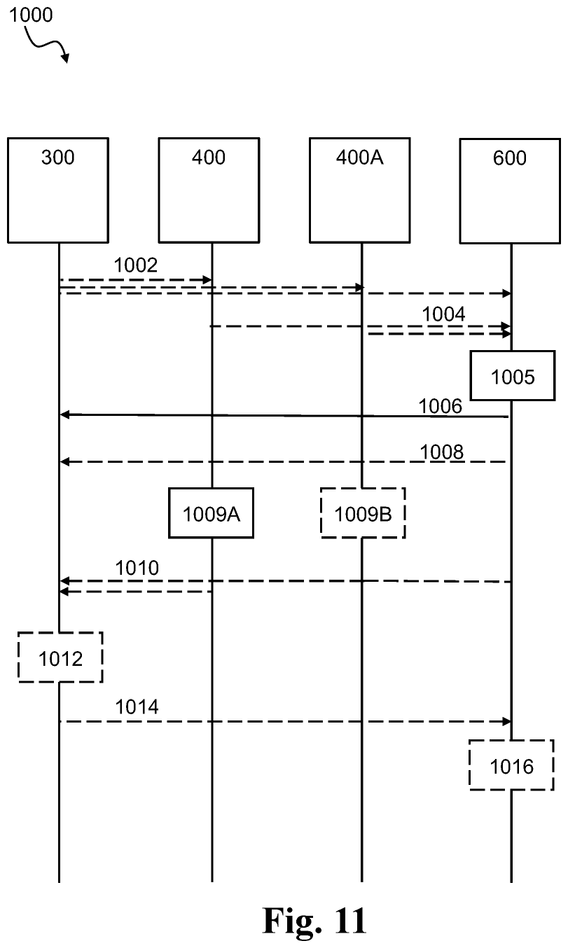

In a DL-based positioning procedure, the wireless device 300 may be referred as a receiver node, whereas the network node 400 may be referred as a transmitter node, such as a transmitter node of a plurality of transmitter nodes required for positioning the receiver node. In a DL-based positioning procedure, the network node 400 may be configured to transmit, to the wireless device 300, a reference signal for positioning the wireless device 300. The network node 400 may be seen as a network node intended to serve the wireless device 300. It may be appreciated that one or more network nodes (such as, network nodes 400A of FIG. 11), such as in addition to the network node 400, can participate in the positioning of the wireless device 300. The one or more network nodes may be seen as assisting transmitter nodes and/or neighboring transmitter nodes. The one or more network nodes may transmit, to the wireless device 300, a reference signal for positioning the wireless device. The DL-based positioning procedure (such as, a direct or Uu-link positioning procedure) is illustrated in FIG. 11.

In an UL-based positioning procedure, the wireless device 300 may be referred as a transmitter node, whereas the network node 400 may be referred as a receiver node, such as a receiver node of a plurality of receiver nodes required for positioning the transmitter node. In an UL-based positioning procedure, the wireless device 300 may be configured to transmit, to the network node 400, a reference signal for positioning the wireless device 300. The network node 400 may be seen as a network node intended to serve the wireless device 300. It may be appreciated that one or more network nodes, such as in addition to the network node 400, can participate in the positioning of the wireless device 300. The one or more network nodes may be seen as assisting receiver nodes and/or neighboring receiver nodes. The one or more network nodes may receive, from the wireless device 300, a reference signal for positioning the wireless device 300.

In a SL-based positioning procedure, the wireless device 300 may be referred to as a transmitter node, such as a transmitter wireless device and/or a first wireless device, whereas the wireless device 300A may be referred as a receiver node, such as a receiver wireless device and/or a second wireless device, or vice versa. In an SL-based positioning procedure, the wireless device 300 is configured to transmit, to the wireless device 300A, a reference signal for positioning the wireless device 300A. The wireless device 300, 300A may be served by a coordinating network node, such as network node 400. An example SL-based positioning procedure (such as, a PC5-link positioning procedure) is illustrated in FIG. 13.

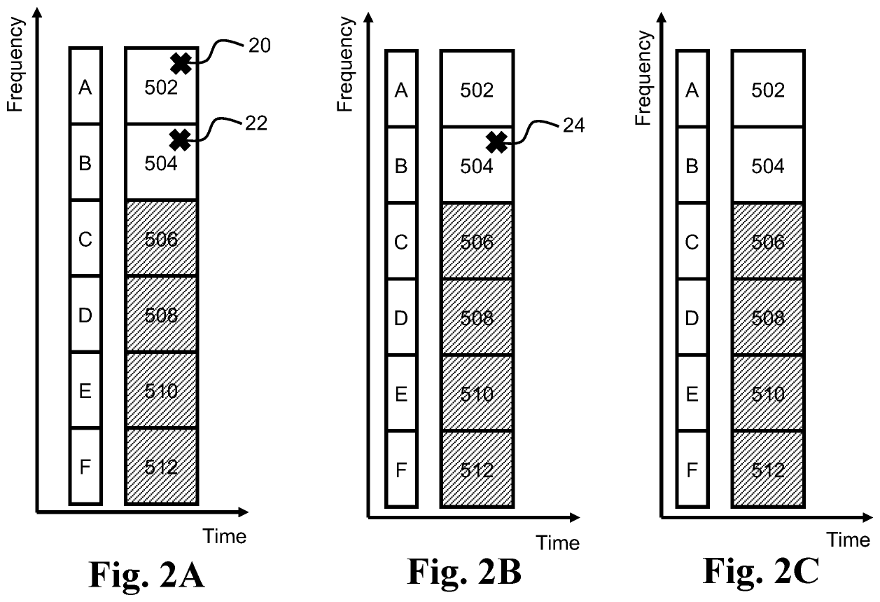

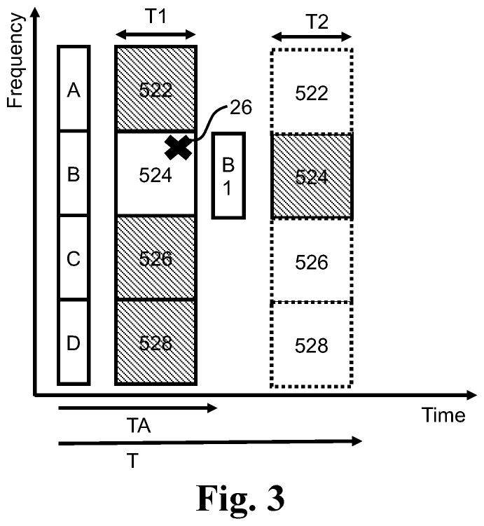

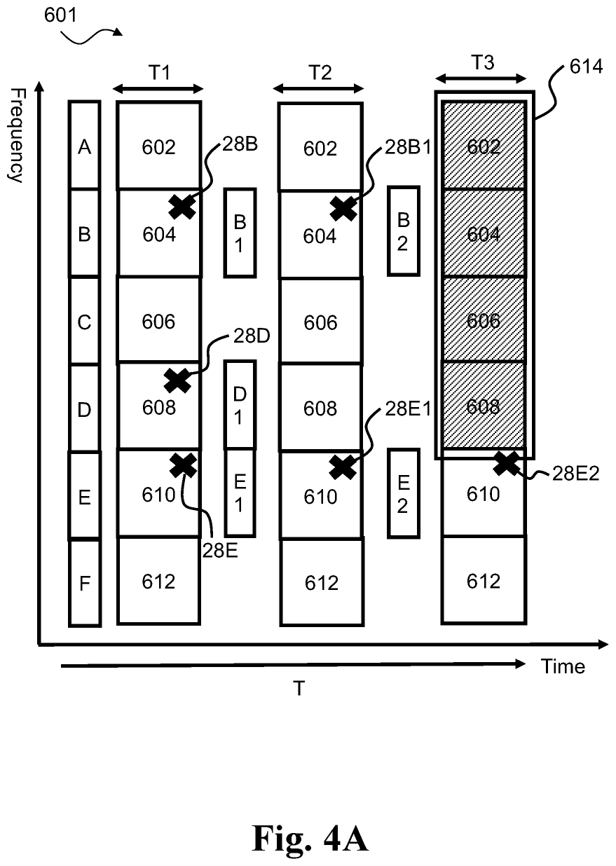

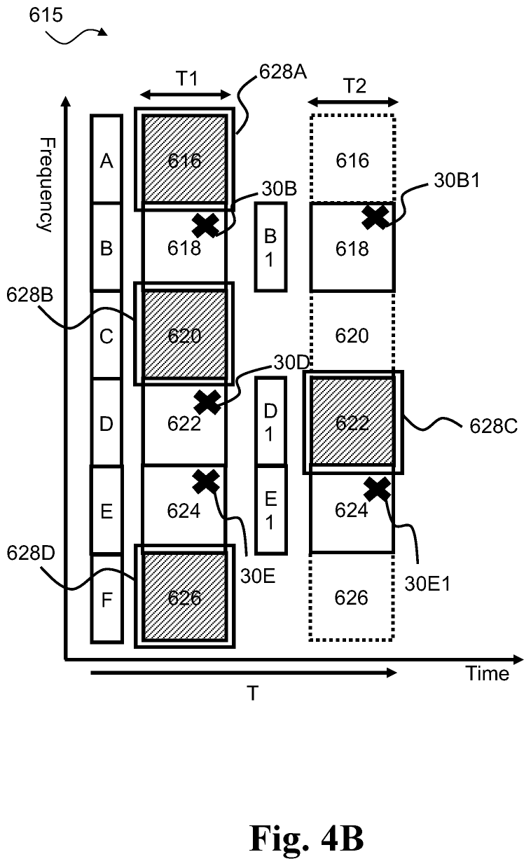

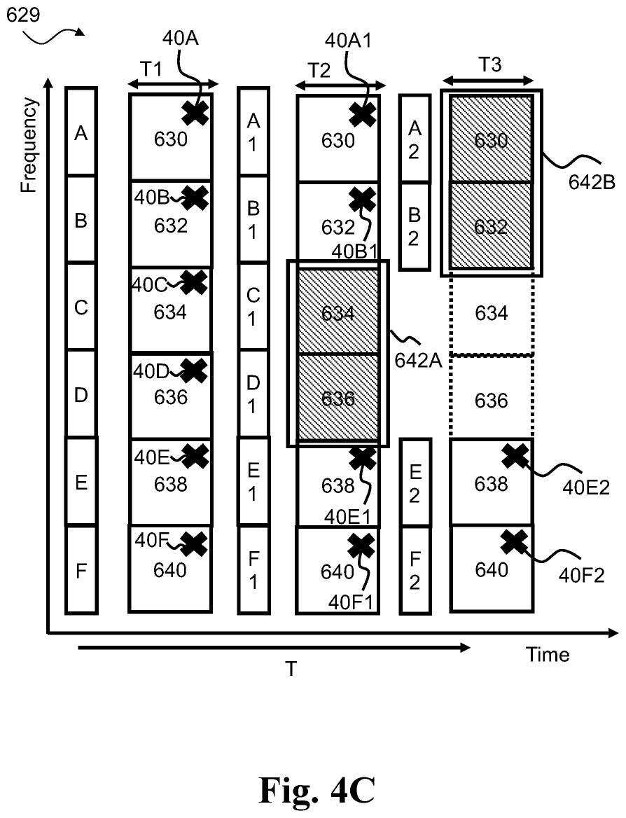

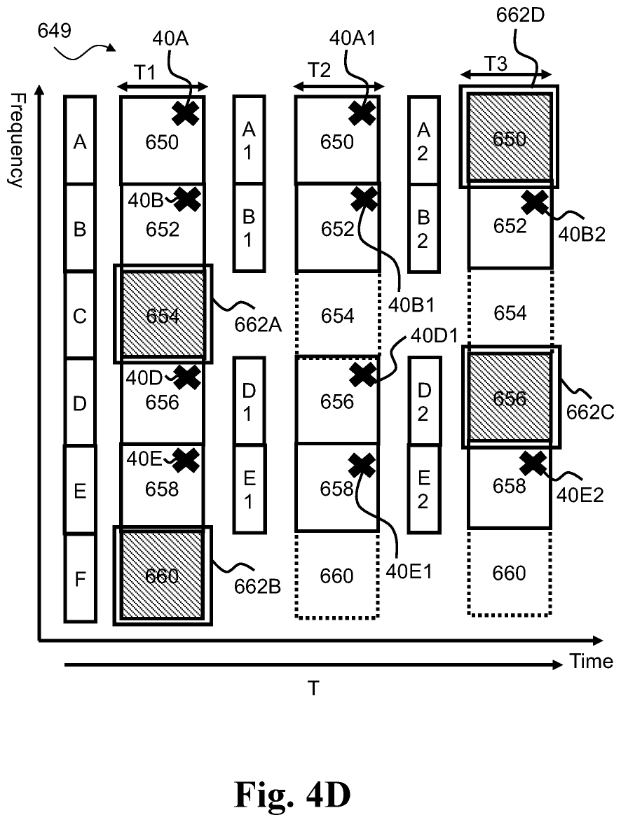

Transmission of a reference signal for positioning from a transmitter node to a receiver node may require allocation of resources to be used for such transmission, such as by a scheduling node. A scheduling node may provide the transmitter node and/or the receiver node with a resource configuration comprising a set of resources, such as a set of allocated resources, to be used for transmission and/or reception of the reference signal. The set of resources may be allocated by the scheduling node in the time and/or frequency domain. In other words, the set of resources may be seen as a set of time slots and/or frequency channels, such as, in one or more unlicensed frequency bands. An example of a resource configuration where a set of required resources for transmitting a reference signal is a subset of a set of allocated resources in the frequency domain is illustrated in FIGS. 2A-2C. An example of a resource configuration where a set of required resources for transmitting a reference signal is a subset of a set of allocated resources in time domain is illustrated in FIG. 3. Examples of resource configurations where a set of required time-frequency resources for transmitting a reference signal is a subset of a set of allocated time-frequency resources in frequency domain and time domain are illustrated in FIGS. 4A-4D. In one or more examples, a set of required resources can be seen as resources required to transmit reference signal in its entirety. In one or more examples, a set of allocated resources can be seen as resources scheduled for transmission of the reference signal. The set of required resources is a subset of the set of allocated resources. The set of required resources may be seen as time-frequency resources required to transmit a reference signal assuming that such time-frequency resources are available. In other words, a scheduling node may provide the transmitter node with a set, such as a number, of allocated resources which is larger than the subset of required resources. The transmitter node may select a set of selected resources among the set of required resources and/or the set of allocated resources. The transmitter node may select the selected resources based on an LBT procedure, such as a procedure enabling the transmitter node to acquire knowledge on the availability of one or more resources of the set of allocated resources. In one or more examples, the transmitter may select the selected resources based on one or more of: the required resources, the allocated resources, and the LBT procedure outcome.

For example, a scheduling node may provide the transmitter node with M allocated resources. The transmitter node may require N required resources to transmit the reference signal, such as N is less than M, such as, where N is a subset of M. The transmitter node may select S selected resources from the M allocated resources. For example, the transmitter node transmits the reference signal in its entirety, such as S is equal to N. It may be appreciated that S is a subset of M. In other word, the set of selected resources S may be seen as a subset of the set of allocated resources M. In one or more example embodiments, the set of selected resources S may be a subset of the set of required resources N. For example, the transmitter node transmits the reference signal partially using a set S of selected resources being a subset of the set of required resources N, such as S is less than N. For example, the transmitter node transmits the reference signal using more than the set of required resources, such as S is higher than N but less than M. In this last example, the transmitter node may need to perform a retransmission of a part of the reference signal that has already been transmitted using a previous resource, but for some reason the receiver node has not been able to properly receive it and/or to perform a satisfactory measurement based on the received reference signal that include such part of the reference signal. For example, the transmitter node transmits the reference signal using more than the set of required resources, such as S is higher than N, and less than or equal to M. In this example, the transmitter node uses more resources than the required resources but less than or the same number of the allocated resources to transmit the reference signal. For example, when N>1 resource, then N may be equal to M, N=M.

A scheduling node may be seen as a network node intended to serve a wireless device that needs to be positioned. In other words, a scheduling node may be seen as one or more of: a resource allocating node, a network node assisted by a resource allocating node, and a coordinating network node assisted by a resource allocation node (such as, in a SL-based positioning procedure (where a first wireless device providing information regarding scheduled resources to a second wireless device) , a wireless device, and a radio network node. For example, a wireless (such as, a first wireless device) can act as a scheduling node and/or a coordinating node when operating in an out-of-coverage scenario, such as for an out-of-coverage SL-based positioning procedure.

As used herein, a reference signal may be construed as a signal that enables a proper time-of-arrival estimation or time synchronization, such as one or more of: a positioning reference signal (PRS), a sounding reference signal (SRS), a Global Navigation Satellite System (GNSS) signal, a primary synchronization signal (PSS), and a secondary synchronization signal (SSS). The reference signal may be seen as a wideband reference signal, such as a signal that spans over one or more channels of an unlicensed frequency band. A reference signal as disclosed herein may be seen as a reference signal for positioning as disclosed herein.

In one or more examples, the transmitter node requires to perform an LBT procedure, such as by sensing a frequency channel, such as from a frequency band, for any energy levels above a threshold to determine if any other node or device is performing a transmission on one or more channels of the unlicensed frequency band, to perform a transmission of a reference signal for positioning to a receiver node.

As the transmitter node may intend to transmit wideband reference signals, such as signals that span over multiple channels of an unlicensed frequency band, the transmitter node may perform a CCA independently for each of the one or more channels of the unlicensed frequency band.

FIGS. 2A-2C illustrate an example of a resource configuration where a set of required resources for transmitting a reference signal is a subset of a set of allocated resources in the frequency domain according to this disclosure. In other words, FIGS. 2A-2C show a set of allocated resources in the frequency domain to be used for transmission of a reference signal, the set of allocated resources being associated with a single time occasion.

A resource configuration in the frequency domain may be indicative of a set of resources allocated being larger in the frequency domain than a set of required resources for transmitting a reference signal. Formulated differently, FIGS. 2A-2C illustrate an example of a resource configuration where a set of allocated resources provide additional resources in the frequency domain compared to the required resources in the frequency domain for N<M transmitting a reference signal. In other words, a resource configuration with additional resources in the frequency domain may be indicative of a set of allocated frequency channels over which transmission of a reference signal is scheduled.

As used herein, a time occasion may be construed as a time at which a possible transmission of a reference signal or part of a reference signal may occur. For example, a time occasion may be seen as a time slot and/or a set of symbols within a time slot where a transmitter node may initiate a transmission of a reference signal using one or more allocated frequency channels.

Stated differently, a time occasion may be seen as a specific time during which a set of resources (such as, a set of frequency channels) can be used to transmit a reference signal. In the embodiment of FIGS. 2A-2C, the set of allocated resources may be part of a resource block (RB), such as a set of frequency channels for the duration of one time slot, such as for the duration of one time occasion.

In the example embodiment of FIGS. 2A-2C, the transmitter node can be configured by a scheduling node with the set of allocated resources, such as M frequency channels, to be used for transmission of a reference signal for positioning. However, the transmission of the reference signal only requires a set of required resources, such as N frequency channels, with N being less than M, such as N<M, among the set of allocated resources for transmission of the reference signal for positioning. The transmitter node may select a set of selected resources, such as S frequency channels, to transmit the reference signal in its entirety or partially. The present disclosure may allow mitigation of LBT failures for an upcoming wideband reference signal transmission by using resource configurations comprising more resources than the ones required for transmission of the reference signal.

In the example embodiment of FIGS. 2A-2C, a scheduling node (such as, a resource allocating node) can allocate a set of resources for transmission of the reference signal, such as M=6 allocated resources. In other words, the scheduling node can configure frequency channels 502, 504, 506, 508, 510, 512 for transmission of the reference signal. The transmitter node may require transmitting the reference signal using N=4 required resources for transmitting the entire reference signal and in turn for ensuring positioning accuracy. Thus, the transmitter node may select a set of required frequency channels, such as N=4 required frequency channels, among the allocated frequency channels 502, 504, 506, 508, 510, 512 to transmit the reference signal in its entirety.

The transmitter node may select the set of required frequency channels by performing an LBT procedure on the allocated frequency channels 502, 504, 506, 508, 510, 512. Stated differently, the transmitter node may perform respective CCAs, A, B, C, D, E, F on each of the frequency channels 502, 504, 506, 508, 510, 512. For example, the transmitter node determines whether one or more of the allocated frequency channels 502, 504, 506, 508, 510, 512 are available to be used for transmission of the reference signal. FIGS. 2A-2C show three scenarios addressing such selection.

In the example embodiment of FIG. 2A, the transmitter node determines that frequency channels 506, 508, 510, 512 are available to be used for transmission of the reference signal, such as the transmitter node senses and/or detect P=4 available frequency channels. In other words, the transmitter node detects respective LBT failures 20, 22 in the allocated frequency channels 502, 504. The transmitter node may transmit the reference signal using the available frequency channels 506, 508, 510, 512. For example, the transmitter node transmits the reference signal using four resources, such as resources comprising the available frequency channels 506, 508, 510, 512, ensuring positioning accuracy.

In the example embodiment of FIG. 2B, the transmitter node determines that frequency channels 502, 506, 508, 510, 512 are available to be used for transmission of the reference signal. In other words, the transmitter node detects an LBT failure 24 in the allocated frequency channel 504. The transmitter node may require using N=4 frequency channels for ensuring positioning accuracy. Although the transmitter node detects P=5 available frequency channels to be used for transmission of the reference signal, the transmitter node may transmit the reference signal using the available frequency channels 506, 508, 510, 512, such as using contiguous frequency channels for transmitting the reference signal.

In the example embodiment of FIG. 2C, the transmitter node determines that frequency channels 502, 504, 506, 508, 510, 512 are available to be used for transmission of the reference signal, such as P=6 available frequency channels. In other words, the transmitter node does not detect an LBT failure in the allocated frequency channels, such in M=6 allocated frequency channels. The transmitter node may require transmitting the reference signal using N=4 frequency channels to ensure positioning accuracy, such as to transmit the entire reference signal. For example, the transmitter node selects S=4 selected frequency channels to transmit the reference signal from the M=6 allocated frequency channels. For example, the set of selected resources is the set of required resources. For example, the transmitter node transmits the reference signal using the set of selected frequency channels, such as frequency channels 506, 508, 510, 512, such as using contiguous frequency channels.

FIG. 3 illustrates an example of a resource configuration where a set of required resources for transmitting a reference signal is a subset of a set of allocated resources in the time domain according to this disclosure. In other words, FIG. 3 shows a set of allocated resources in the time domain to be used for transmission of a reference signal, the set of allocated resources being associated with at least two time occasions. Stated differently, FIG. 3 shows a set of allocated resources arranged in the time domain. In one or more examples, a set of allocated resources can be seen as time-frequency resources scheduled for transmission of the reference signal. In one or more examples, a set of required resources can be seen as time-frequency resources required to transmit the reference signal assuming that such time-frequency resources are available, such as assuming that a CCA procedure is successful. In one or more examples, a time-frequency resource can be seen as a frequency channel associated with a time occasion. For example, a resource can be seen as frequency channel through which a reference signal is transmitted at a specific time occasion.

A resource configuration in the time domain may be indicative of a set of resources allocated being larger in the time domain than a set of required resources for transmitting a reference signal. Formulated differently, FIG. 3 illustrates an example of a resource configuration where a set of allocated resources provide additional resources in the time domain compared to the required resources in the time domain for transmitting a reference signal. In other words, a resource configuration with additional resources in the time domain may be indicative of a set of allocated time occasions with associated frequency channels over which transmission of a reference signal is scheduled. In other words, a resource configuration in the time domain may be indicative of a set of time occasions during which a set of resources (such as, a set of frequency channels) can be used to transmit a reference signal. A resource configuration indicative of a set of resources arranged in the time domain may be seen as a set of frequency channels, with each frequency channel being associated with at least two time occasions. In the embodiment of FIG. 3, the set of allocated resources may be part of at least two RBs, such as a set of frequency channels for the duration of at least two time slots.

In the embodiment of FIG. 3, the transmitter node can be configured by a scheduling node with the set of allocated resources arranged in the time domain, such as a set of resources comprising a first number of time occasions, to be used for transmission of a reference signal for positioning. However, the transmission of the reference signal may only require a set of required resources, such as a set of resources comprising a second number of time occasions. The first number of time occasions is greater than or equal to the second number of time occasions. The present disclosure may allow mitigation of LBT failures for an upcoming wideband reference signal transmission by using resource configurations comprising resources associated with more time occasions than the ones required for transmission of the reference signal.

In the embodiment of FIG. 3, the scheduling node can configure frequency channels 522, 524, 526, 528 for transmission of the reference signal at one or more time occasions. In one or more examples, the scheduling node determines a resource configuration comprising M=8 allocated resources. In one or more examples, the M=8 allocated resources can be seen as four frequency channels, such as frequency channels 522, 524, 526, 528, with each frequency channel being associated with two time occasions, such as a first time occasion T1 and second time occasion T2. The transmitter node may require N=4 required resources for transmitting the entire reference signal and in turn for ensuring positioning accuracy. In one or more examples, the set of allocated resources provides M-N, such as four, additional resources compared to the required resources for transmitting a reference signal.

The transmitter node may select a set of selected frequency channels S, such as based on the number of required frequency channels N, by performing an LBT procedure on frequency channels associated with a first time occasion T1, such as on the allocated frequency channels 522, 524, 526, 528. Stated differently, the transmitter node may perform respective CCAs, A, B, C, D on each of the frequency channels 522, 524, 526, 528. For example, the transmitter node determines whether one or more of the frequency channels 522, 524, 526, 528 are available to be used for transmission of the reference signal.

The transmitter node may determine that the frequency channels 522, 526, 528, such as the frequency channels associated with the first time occasion T1, are available to be used for transmission of the reference signal. For example, the transmitter node detects P=3 available frequency channels. In other words, the transmitter node may detect LBT failure 26 in the allocated frequency channel 524. In other words, the transmitter node may transmit a first part of the reference signal, a third part of the reference signal, a fourth part of the reference signal using the available and selected frequency channels 522, 526, 528, respectively. In one or more examples, the transmitter node selects S=3 frequency channels from the P=3 available frequency channels to be used for a partial transmission of the reference signal. For example, the transmitter node partially transmits the reference signal using the available frequency channels 522, 526, 528, such as P=S=3 frequency channels.

The transmitter node may be configured to continue monitoring the availability of the frequency channel 524 to be used for transmission of a second part of the reference signal.

The transmitter node may perform an additional CCA B1 on the frequency channel 524, with the frequency channel 524 being associated with a second time occasion, such as time occasion T2. Stated differently, the transmitter node performs the CCA B1 on the frequency channel 524 after a time TA. The time TA may be measured in relation to the CCA B. For example, the time TA is a time associated with an earliest CCA on the frequency channel 524 after the transmission of the first part of the reference signal, the third part of the reference signal, the fourth part of the reference signal using the available frequency channels 522, 526, 528, respectively, is performed. Stated differently, TA may be seen as a time to re-attempt CCA, such as to perform CCA B1, on the frequency channel 524. For example, the transmitter node determines whether the frequency channel 524 is available to be used for transmission of the second part of the reference signal. For example, the transmitter node determines P=1 available frequency channel to transmit the second part of the reference signal. The transmitter node may transmit the second part of the reference signal using the available frequency channel 524 at the second time occasion T2. In one or more examples, time window T is indicative of the number of allocated resources arranged in the time domain. In one or more examples, the time window is indicative of a set of time occasions. In the embodiment of FIG. 3, time window T can comprise the first time occasion and the second time occasion. In one or more examples, time TA is indicative of a time to perform an additional CCA on a frequency channel detected as unavailable, with such unavailable frequency channel to be used for transmission of a part of a reference signal at a previous time occasion. Time window T and/or time T1 may not exceed a maximum COT time, such as a COT length. In one or more examples, frequency channels 522, 526, 522 associated with the second time occasion T2 can be seen as allocated but unused frequency channels, such as frequency channels not used for transmission of the reference signal. In one or more examples, the unused frequency channels, such as frequency channels 522, 526, 522 associated with the second time occasion T2, can be used by other technologies and/or communication systems (such as, Wi-Fi, Bluetooth, among others).

FIG. 3 may illustrate a scenario where a transmitter node obtains M=8 allocated resources from the scheduling node. For example, the transmitter node requires N=4 required resources for transmission of the reference signal. For example, the transmitter node detects P=4 available frequency channels, such as P=3 available frequency channels associated with the first time occasion T1, and P=1 available frequency channel associated with the second time occasion T2. For example, the transmitter node selects S=4 selected frequency channels, such as S=3 selected frequency channels associated with the first time occasion T1, and S=1 selected frequency channel associated with the second time occasion T2. For example, the transmitter node transmits the first part, second part, third part, and the fourth part using S=N=4 time-frequency resources among M=8 allocated resources.

FIGS. 4A-4D show examples of resource configurations where sets of required time-frequency resources for transmitting a reference signal are subsets of sets of allocated time-frequency resources in frequency and time domains according to this disclosure. In other words, FIGS. 4A-4D show a set of allocated resources in the frequency domain to be used for transmission of a reference signal, the set of allocated resources being associated with a plurality of time occasions. A resource configuration in the time-frequency domain may be indicative of a set of resources allocated being larger in the time-frequency domain than a set of required resources for transmitting a reference signal. Formulated differently, FIGS. 4A-4D illustrate examples of resource configurations where a set of allocated resources provide additional resources in the time-frequency domain compared to the required resources in the time-frequency domain for transmitting a reference signal. In other words, a resource configuration with additional resources in the time-frequency domain may be indicative of a set of allocated frequency channels and/or a set of allocated time occasions over which transmission of a reference signal is scheduled. In other words, the set of allocated resources comprises a number of time-frequency resources, such as resources allocated in the time and frequency domains. In the embodiment of FIGS. 4A-4D, the set of allocated resources may be part of at least two RBs, such as a set of frequency channels for the duration of at least two time slots.

A transmitter node can be configured by a scheduling node with the set of allocated resources, such as a first number of time-frequency resources, to be used for transmission of a reference signal for positioning. However, the transmission of the reference signal only requires a set of required resources, such as a second number of time-frequency resources, for transmission of the reference signal for positioning, with the first number of time-frequency resources being greater than the second number of time-frequency resources.

FIG. 4A shows an example resource configuration 601 for transmission of a reference signal using contiguous frequency channels, such as frequency channels being in sequence with respect to each other and associated with a same time occasion.

The transmitter node may be configured to transmit, to a receiver node, a reference signal extending over a number of contiguous frequency channels, such as N=4 contiguous frequency channels. The transmitter node may intend to transmit a reference signal using a number of contiguous frequency channels as the receiver node is not capable of applying a frequency combining procedure to a plurality of parts of the reference signal when the reference signal is transmitted by the transmitted node using a number of non-contiguous frequency channels, such as parts of the reference signal transmitted at different time occasions. In other words, the receiver node may only be able to receive parts of the reference signal via frequency channels being contiguous and at the same time occasion. For example, a frequency combining procedure is a procedure to aggregate the received reference signal in multiple frequency channels. The frequency combining procedure may involve frequency stitching, in which there is a phase correction between two adjacent frequency channels.

The scheduling node may determine a resource configuration based on a length of the reference signal, such as a length defined as the number of frequency channels required to transmit the reference signal. The scheduling node can configure and/or allocate frequency channels 602, 604, 606, 608, 610, 612 for transmission of the reference signal. In other words, the transmitter node may receive a resource configuration indicative of a set of allocated resources comprising the frequency channels 602, 604, 606, 608, 610, 612. For example, the frequency channels 602, 604, 606, 608, 610, 612 are associated with a first time occasion, a second time occasion, and a third time occasion. In one or more examples, the scheduling node determines a resource configuration comprising M=18 allocated resources. In one or more examples, the M=18 allocated resources can be seen as six frequency channels, such as frequency channels 602, 604, 606, 608, 610, 612, with each frequency channel being associated with three time occasions, such as a first time occasion T1, second time occasion T2, and third time occasion T3. The transmitter node may require N=4 required resources for transmitting the entire reference signal and in turn for ensuring positioning accuracy. For example, time T is indicative of a time window during which the transmitter node is expected to transmit the reference signal, and/or the receiver node is expected to receive the reference signal. The time window T comprises the first time occasion T1, the second time occasion T2 and the third time occasion T3.

The transmitter node may select a set of selected frequency channels S, such as based on the number of required frequency channels N, from the allocated frequency channels 602, 604, 606, 608, 610, 612, by performing an LBT procedure on the allocated frequency channels 602, 604, 606, 608, 610, 612, such as the allocated frequency channels 602, 604, 606, 608, 610, 612 associated with the first time occasion T1.

Stated differently, the transmitter node may perform a respective first CCAs A, B, C, D, E, F on each of the frequency channels 602, 604, 606, 608, 610, 612. For example, the transmitter node determines whether one or more of the frequency channels 602, 604, 606, 608, 610, 612 are available to be used for transmission of the reference signal. The transmitter node may determine that the frequency channels 602, 606, 612, such as associated with the first time occasion T1, are available to be used for transmission of the reference signal. For example, the transmitter node detects P=3 available frequency channels. However, the transmitter node may intend to transmit the reference signal in N=4 contiguous frequency channels. The transmitter node may therefore not be able to successfully transmit the entire reference signal at the first time occasion, as N is greater than P. Therefore, the transmitter node may be configured to repeat the reference signal transmission in the time domain during the time window T.

For example, the transmitter node can transmit a first, second, and third parts of the reference signal (such as, three portions and/or parts of the reference signal) using the available frequency channels 602, 606, 612 associated with the first time occasion. For example, the transmitter node selects S=3 selected frequency channels from the P=3 available frequency channels for transmission of the first, second, and third parts of the reference signal. In one or more examples, the set of selected frequency channels is equal to the set of available channels, such as P=S=3 frequency channels. In one or more examples, the transmitter node transmits the first, second, and third parts of the reference signal using the available frequency channels 602, 606, 612 since the transmitter node may need to occupy and/or use such channels, such as in response to successful CCAs A, C, F.

For example, the transmitter node determines that the frequency channels 604, 608, 610 associated with the first time occasion T1 are unavailable to be used for transmission of the reference signal. For example, the transmitter node detects LBT failures 28B, 28D, 28E in the frequency channels 604, 608, 610 associated with the first time occasion T1.

The transmitter node may require performing a respective second CCAs B1, D1, E1 on each of the frequency channels 604, 608, 610 associated with the second time occasion T2. For example, the transmitter node determines whether one or more of the frequency channels 604, 608, 610 are available to be used for transmission of the reference signal at the second time occasion T2. The transmitter node may determine that the frequency channel 608, such as associated with the second time occasion T2, is available to be used for transmission of a part of the reference signal.

For example, the transmitter node can transmit a fourth part of the reference signal using the available frequency channel 608 associated with the second time occasion. In one or more examples, the transmitter node selects S=1 selected frequency channels from P=1 available frequency channels for transmission of the fourth part of the reference signal. In one or more examples, the transmitter node transmits the fourth part of the reference signal using the available frequency channels 608 since the transmitter node needs to occupy and/or use such channel, such as in response to a successful CCA D1.

The transmitter node may repeat transmission of the first, second, and third parts of the reference signal using the frequency channels 602, 606, 612 associated with the second time occasion T2. For example, the transmitter node is configured to, in response to the successful CCAs A, C, F on the allocated frequency channels 602, 606, 612 associated with the first time occasion T1, transmit the first, second, and third parts of the reference signal over the frequency channels 602, 606, 612 associated with following time occasions, such as the second time occasion T2 and/or the third time occasion T3. For example, the transmitter node is configured to, in response to the successful CCAs A, C, F on the allocated frequency channels 602, 606, 612 associated with the first time occasion T1, transmit the first, second, and third parts of the reference signal over the frequency channels 602, 606, 612 associated with the first time occasion T1, such as over available frequency channels. The transmitter node may perform additional CCAs, such as CCAs A1, C1, F1 (not shown in FIG. 4A), on the frequency channels 602, 606, 612 associated with the second time occasion T2. The transmitter node may be configured to, in response to successful CCAs A1, C1, F1, transmit a part of the reference signal over the frequency channels 602, 606, 612 associated with the second time occasion T2, such as over available frequency channels.

The transmitter node may determine that the frequency channels 604, 610 associated with the second time occasion T2 are unavailable to be used for transmission of a remaining part of the reference signal. For example, the transmitter node detects LBT failures 28B1, 28E1 in the frequency channels 604, 610 associated with the second time occasion T2. Although the transmitter node can select S=4 selected frequency channels, such as S=3 selected frequency channels associated with the first time occasion T=1 and a S=1 selected frequency channel associated with the second time occasion T=2, which may fulfil the requirement to transmit the reference signal using N=4 required frequency channels, such S=4 selected frequency channels may not fulfil the requirement to transmit the reference signal in N=4 contiguous frequency channels (such as, in consecutive frequency channels associated with the same time occasion and/or time slot). The transmitter node may therefore not be able to successfully transmit the entire reference signal on contiguous frequency channels at the second time occasion.

The transmitter node may be configured to continue monitoring the availability of one or more and/or on each of the allocated frequency channels 602, 604, 606, 608, 610, 612 associated with following time occasions to be used for transmission of the reference signal. For example, the transmitter node is configured to continue monitoring the availability of the allocated frequency channels 602, 604, 606, 608, 610, 612 associated with the third time occasion to be used for transmission of parts of the reference signal. For example, the transmitter node is configured to continue monitoring the availability of the allocated frequency channels 604, 610 associated with the third time occasion to be used for transmission of remaining parts of the reference signal, such as allocated frequency channels associated with the first time occasion T1 and the second time occasion T2 unavailable to perform transmission of parts of the reference signal.

For example, the transmitter node may require performing a respective third CCA B2, E2 on each of the frequency channels 604, 610 associated with the third time occasion T3. For example, the transmitter node determines whether one or more of the frequency channels 604, 610 are available to be used for transmission of the reference signal. The transmitter node may determine that the frequency channel 604, such as associated with the third time occasion T3, is available to be used for transmission of a remaining part of the reference signal.

For example, the transmitter node can transmit a fifth part of the reference signal (such as, a portion of the reference signal) using the available frequency channel 604 associated with the third time occasion T3. The transmit node may repeat transmission of the first, second, third, and fourth part of the reference signal using the frequency channels 602, 606, 608, 612 associated with the third time occasion T3. The transmitter node may determine that the frequency channel 610 associated with the second time occasion is unavailable to be used for transmission of a part of the reference signal. The transmitter node may detect an LBT failure 28E2 in the frequency channel 610.

For example, although the transmitter node detects the LBT failure 28E2 in the frequency channel 610, which can imply performing an additional CCA on the frequency channel 610, the transmitter node can transmit the reference signal, such as the first, second, third, fourth parts of the reference signal, using the contiguous frequency channels 602, 604, 606, 608 associated with the third time occasion T3, as illustrated by 614. In one or more examples, the fifth part of the reference signal transmitted using the frequency channel 604 is the third part of the reference signal as the receiver node may only be capable of processing a reference signal received using contiguous frequency channels. The transmitter node may be capable of fulfilling the requirement of transmitting the reference signal using N=4 contiguous frequency channels. The transmitter node may therefore be able to successfully transmit the entire reference signal at the third time occasion T3. The transmission of the reference signal may be stopped when such requirement is fulfilled. In one or more examples, FIG. 4A can include more LBT failures than the LBT failures 28B, 28D, 28E, 28B1, 28E1, 28E2. In one or more examples, the transmitter node may stop transmission of the reference signal, such as stop monitoring the allocated frequency channels, when the reference signal has been transmitted in its entirety in contiguous frequency channels, and/or when the maximum number of time domain resources is reached (such as, when the maximum number of time occasions, each time occasion being associated with a number of frequency channels is reached), and/or when the COT length of each allocated frequency channels runs out.

In the embodiment of FIG. 4A, the transmission of the reference signal is repeated in the time domain during the window time T. The transmitter node performs CCA on each of the frequency channels 602, 604, 606, 608, 610, 612. When the CCA on a frequency channel is successful, such as when the frequency channel is available to transmit a part of the reference signal, the transmitter node transmits a corresponding part of the reference signal using such frequency channel. When the CCA on a frequency channel is unsuccessful, such as when the frequency channel is unavailable to transmit a part of the reference signal, the transmitter node performs additional CCAs on each of the unavailable frequency channels until one or more of: such CCAs become successful, when the reference signal has been transmitted in its entirety in contiguous frequency channels, when the maximum number of time domain resources is reached, and when the COT of the available frequency channels runs out (such as, the COT of frequency channels 602, 604, 608, 612 associated with the first time occasion and/or second time occasion and/or third time occasion). In other words, the transmission of the reference signal, such as of parts of the reference signal, may be repeated until the N-long reference signal (such as, a reference signal with N parts) has been transmitted using N-contiguous frequency channels at a specific time occasion.

In one or more examples, the transmitter node can transmit the reference signal and/or parts of the reference signal and receive, such as listen for, an acknowledgment indicative of the availability of the allocated frequency channels, simultaneously in each of the allocated frequency channels, as the CCAs may run in parallel with the transmission of the reference signal and/or parts of the reference signal.

In one or more examples, the transmitter node can either transmit the reference signal and/or parts of the reference signal or listen for the acknowledgment indicative of the availability of the first number of frequency channel at a given time in each of the allocated frequency channels.

In one or more examples, the CCA on each of the allocated frequency channels may not run continuously but at specific intervals when the transmitter node listens for the acknowledgment to use one or more of the allocated frequency channels.

FIG. 4B shows an example resource configuration 615 for transmission of a reference signal using non-contiguous frequency channels, such as frequency channels associated with at least two time occasions.

The transmitter node may be configured to transmit, to a receiver node, a reference signal using N=4 and still allowed to use non-contiguous frequency channels. The transmitter node may transmit a reference signal using a number of non-contiguous frequency channels as the receiver node is capable of combining a plurality of parts of the reference signal when the plurality of parts is transmitted using respective non-contiguous frequency channels, such as frequency channels associated with at least two time occasions. For example, the transmitter node uses non-contagious frequency channels as the contagious option is not possible primarily due to the LBT failure.

The scheduling node may determine a resource configuration based a length of the reference signal, such as a length defined as the number of frequency channels required to transmit the reference signal. The scheduling node may determine a resource configuration based on a capability message indicative of a capability of the receiver node to combine the plurality of parts of the reference signal received using the non-contiguous frequency channels.

The scheduling node can configure frequency channels 616, 618, 620, 622, 624, 626 for transmission of the reference signal. In other words, the transmitter node may receive a resource configuration indicative of a set of allocated resources comprising the frequency channels 616, 618, 620, 622, 624, 626. For example, the frequency channels 616, 618, 620, 622, 624, 626 are associated with a first time occasion T1, and a second time occasion T2. In one or more examples, the scheduling node determines a resource configuration comprising M=12 allocated resources. In one or more examples, the M=12 allocated resources can be seen as six frequency channels, such as frequency channels 616, 618, 620, 622, 624, 626, with each frequency channel being associated with two time occasions, such as a first time occasion T1 and second time occasion T2. The transmitter node may require N=4 required resources for transmitting the entire reference signal and in turn for ensuring positioning accuracy. For example, time T is indicative of a time window during which the transmitter node is expected to transmit the reference signal, and/or the receiver node is expected to receive the reference signal. The time window T comprises the first time occasion and the second time occasion.

The transmitter node may a set of selected frequency channels S, such as based on the number of required frequency channels N, from the allocated frequency channels 616, 618, 620, 622, 624, 626 by performing an LBT procedure on the allocated frequency channels 616, 618, 620, 622, 624, 626, the allocated frequency channels 616, 618, 620, 622, 624, 626 being associated with the first time occasion T1.

Stated differently, the transmitter node may perform a respective first CCA A, B, C, D, E, F on each of the frequency channels 616, 618, 620, 622, 624, 626. For example, the transmitter node determines whether one or more of the frequency channels 616, 618, 620, 622, 624, 626 are available to be used for transmission of the reference signal. The transmitter node may determine that the frequency channels 616, 620, 626, such as associated with the first time occasion T1, are available to be used for transmission of the reference signal. For example, the transmitter node detects P=3 available frequency channels. However, the transmitter node may intend to transmit the reference signal in N=4 non-contiguous frequency channels. Therefore, the transmitter node may not be able to successfully transmit the entire reference signal at the first time occasion T1 as N is greater than P. The transmitter node may be configured to repeat the reference signal transmission in the time domain during the time window T.

For example, the transmitter node can transmit a first part 628A, a second part 628B, and a third part 628D of the reference signal (such as, three portions of the reference signal) using the available frequency channels 616, 620, 626 associated with the first time occasion T1. For example, the transmitter node determines that the frequency channels 618, 622, 624 associated with the first time occasion are unavailable to be used for transmission of the reference signal.

For example, the transmitter node detects LBT failures 30B, 30D, 30E in the frequency channels 618, 622, 624 associated with the first time occasion T1.

The transmitter node may require performing a respective second CCA B1, D1, E1 on each of the frequency channels 618, 622, 624 associated with the second time occasion T2. For example, the transmitter node determines whether one or more of the frequency channels 618, 622, 624 are available to be used for transmission of the reference signal. The transmitter node may determine that the frequency channel 622, such as associated with the second time occasion T2, is available to be used for transmission of a remaining part of the reference signal. The transmitter node may detect a P=1 available frequency channel. For example, the transmitter node can transmit a fourth part 628C of the reference signal using the available frequency channel 608 associated with the second time occasion T2.

The transmitter node may determine that the frequency channels 618, 624 associated with the second time occasion T2 are unavailable to be used for transmission of a remaining part of the reference signal. In one or more examples, the remaining part of the reference signal that can be transmitted using the frequency channels 618, 624 associated with the second time occasion T2 can be the fourth part 628C of the reference signal as the transmitter has already transmitted the first part 628A, a second part 628B, and a third part 628D of the reference signal using the frequency channels 616, 620, 626 at the first time occasion T1. The transmitter node may detect LBT failures 30E1, 30B1 in the frequency channels 624, 618. In one or more examples, the transmitter node may stop transmission of the reference signal, such as stop monitoring the allocated frequency channels, when the reference signal has been transmitted in its entirety in non-contiguous frequency channels, and/or when the maximum number of time domain resources is reached (such as, when the maximum number of time occasions, each time occasion being associated with a number of frequency channels is reached), and/or when the COT length of each available frequency channel runs out (such as, the COT of frequency channels 616, 620, 622, 626 associated with the first time occasion and/or second time occasion).

For example, although the transmitter node detects the LBT failures 30E1, 32B1 in the frequency channels 624, 618, the transmitter node can transmit the reference signal using the frequency channels 616, 620, 622, 626, with the frequency channels 616, 620, 626 being associated with the first time occasion T1 and the frequency channel 622 being associated with the second time occasion. The transmitter node may be capable of fulfilling the requirement of transmitting the reference signal using N=4 non-contiguous frequency channels. Thus, the transmission of the first part 628A, the second part 628B, the third part 628D, and the fourth part 628C may stop independently on each frequency channel 616, 620, 626, 622 as soon as the first part 628A, the second part 628B, the third part 628D, the fourth part 628C have been transmitted.

FIG. 4B may illustrate a scenario where a transmitter node obtains M=12 allocated resources from the scheduling node. For example, the transmitter node requires N=4 required resources for transmission of the reference signal in its entirety. For example, the transmitter node detects P=4 available frequency channels, such as P=3 available frequency channels associated with the first time occasion T1, and P=1 available frequency channel associated with the second time occasion T2. For example, the transmitter node selects S=4 selected frequency channels, such as S=3 selected frequency channels associated with the first time occasion T1, and S=1 selected frequency channel associated with the second time occasion T2. For example, the transmitter node transmits the first part, second part, third part, and the fourth part using S=N=4 time-frequency resources among M=12 allocated resources. In one or more examples, frequency channels 616, 620, 626 associated with the second time occasion T2 can be seen as allocated but unused frequency channels, such as frequency channels not used for transmission of the reference signal. In one or more examples, the unused frequency channels, such as frequency channels 616, 620, 626 associated with the second time occasion T2, can be used by other technologies and/or communication systems (such as, Wi-Fi, Bluetooth, among others).

In the embodiment of FIG. 4B, the transmission of the several parts of the reference signal may stop independently on each frequency channel as soon as the corresponding part of the reference signal has been transmitted.

FIG. 4C shows an example resource configuration 629 for transmission of a reference signal using contiguous frequency channels, with each of the contiguous frequency channels being associated with at least two time occasions. FIG. 4C shows a resource configuration for transmission of a reference signal using a first set of contiguous frequency channels 642A, such as frequency channels associated with a second time occasion T2, and a second set of contiguous frequency channels 642B, such as frequency channels associated with a third time occasion T3.

The scheduling node may determine a resource configuration based a length of the reference signal, such as a length defined as the number of frequency channels required to transmit the reference signal, such as N=4 frequency channels. The scheduling node may determine a resource configuration based on a capability message indicative of a capability of the receiver node to combine the plurality of parts of the reference signal received using the first set of contiguous frequency channels 642A and the second set of contiguous frequency channels 642B.

The scheduling node can configure frequency channels 630, 632, 634, 636, 638, 640 for transmission of the reference signal. In other words, the transmitter node may receive a resource configuration indicative of a set of allocated resources comprising the frequency channels 630, 632, 634, 636, 638, 640. For example, the frequency channels 630, 632, 634, 636, 638, 640 are associated with a first time occasion T1 and a second time occasion T2, and a third time occasion. For example, time T is indicative of a time window during which the transmitter node is expected to transmit the reference signal, and/or the receiver node is expected to receive the reference signal. The time window T comprises a set of time occasions, such as the first time occasion and the second time occasion and the second time occasion.

The transmitter node may select a set of selected frequency channels S, such as based on the number of required frequency channels N, such as frequency channels associated with a second and a third time occasions, from the allocated frequency channels 630, 632, 634, 636, 638, 640 by performing an LBT procedure on the allocated frequency channels 630, 632, 634, 636, 638, 640, the allocated frequency channels 630, 632, 634, 636, 638, 640 associated with the first, second, and third time occasions.

The transmitter node may perform a respective first CCA A, B, C, D, E, F on each of the frequency channels 630, 632, 634, 636, 638, 640 associated with the first time occasion T1. For example, the transmitter node determines whether one or more of the frequency channels 630, 632, 634, 636, 638, 640 are available to be used for transmission of the reference signal. The transmitter node may determine that the frequency channels 630, 632, 634, 636, 638, 640, such as associated with the first time occasion, are unavailable to be used for transmission of the reference signal. For example, the transmitter node detects LBT failures 40A, 40B, 40C, 40D, 40E, 40F in the frequency channels 630, 632, 634, 636, 638, 640 associated with the first time occasion T1.

The transmitter node may require performing a respective second CCA A1, B1, C1, D1, E1, F1 on each of the frequency channels 630, 632, 634, 636, 638, 640 associated with the second time occasion T2. For example, the transmitter node determines whether one or more of the frequency channels 630, 632, 634, 636, 638, 640 are available to be used for transmission of the reference signal. The transmitter node may determine that the frequency channels 634, 636, such as associated with the second time occasion T2, are available to be used for transmission of a corresponding part of the reference signal. For example, the transmitter node detects P=2 available frequency channels. For example, the transmitter node can transmit a first part and a second part of the reference signal using the available frequency channels 634, 636, respectively, associated with the second time occasion T2. For example, the first part and the second part of the reference signal may be transmitted using the first set of contiguous frequency channels 642A, such as contiguous frequency channels associated with the second time occasion T2.

The transmitter node may determine that the frequency channels 630, 632, 638, 640 associated with the second time occasion T2 are unavailable to be used for transmission of remaining parts of the reference signal. For example, the transmitter node detects LBT failures 40A1, 40B1, 40E1, 40F1 in the frequency channels 630, 632, 638, 640 associated with the second time occasion T2. The transmitter node may require performing a respective third CCA A2, B2, E2, F2 on each of the frequency channels 630, 632, 638, 640 associated with the third time occasion T3. For example, the transmitter node determines whether one or more of the frequency channels 630, 632, 638, 640 are available to be used for transmission of the remaining parts of the reference signal. The transmitter node may determine that the frequency channels 630, 632, such as associated with the third time occasion, are available to be used for transmission of a corresponding part of the reference signal. For example, the transmitter node detects P=2 available frequency channels. For example, the transmitter node can transmit a third part and a fourth part of the reference signal using the available frequency channels 630, 632, respectively, associated with the third time occasion T3. For example, the third part and a fourth part of the reference signal may be transmitted using the second set of contiguous frequency channels 642B, such as contiguous frequency channels associated with the third time occasion T3.

The transmitter node may determine that the frequency channels 638, 640 associated with the third time occasion T3 are unavailable to be used for transmission of remaining parts of the reference signal. The transmitter node may detect LBT failures 40E2, 40F2 in the frequency channels 638, 640 associated with the third time occasion T3. In one or more examples, the transmitter node may stop transmission of the reference signal, such as stop monitoring the allocated frequency channels, when the reference signal has been transmitted in its entirety in contiguous frequency channels but associated with different time occasions, and/or when the maximum number of time domain resources is reached (such as, when the maximum number of time occasions, each time occasion being associated with a number of frequency channels is reached), and/or when the COT length of each available frequency channel runs out (such as, the COT of frequency channels 630, 632, 634, 636 associated with the second time occasion and/or third time occasion).

For example, although the transmitter node detects the LBT failures 40E2, 40F2 in the frequency channels 638, 640, the transmitter node can transmit the reference signal using the frequency channels 630, 632, 634, 636, with the frequency channels 634, 636 being associated with the second time occasion T2 and the frequency channels 630, 632 being associated with the third time occasion T3. The transmitter node may be capable of fulfilling the requirement of transmitting the reference signal using N=4 frequency channels. The reference signal may be transmitted using frequency channels, such as using N=2 contiguous frequency channels associated with a second time occasion T2 and N=2 contiguous frequency channels associated with a third time occasion T3. The transmission of the first part and the second part using the first set contiguous frequency channels may stop as soon as the first part and the second part has been transmitted. The transmission of the third part and the fourth part using the second set of contiguous frequency channels may stop as soon as the third part and the fourth part has been transmitted. Optionally, the transmission of the first part, the second part, the third, and the fourth can stop independently on each frequency channel 630, 632, 634, 636 as soon as the first part, the second part, the third part, the fourth part have been transmitted. For example, transmissions of reference signals using the first and the second set of contiguous channels can be a result of a number of unsuccessful CCAs on the respective frequency channels leading to such selection. Thus, in embodiment of FIG. 4C, the transmission of the several parts of the reference signal may also stop independently on each frequency channel as soon as the corresponding part of the reference signal has been transmitted.

FIG. 4C may illustrate a scenario where a transmitter node obtains M=18 allocated resources from the scheduling node. For example, the transmitter node requires N=4 required resources for transmission of the reference signal in its entirety. For example, the transmitter node detects P=4 available frequency channels, such as P=2 available contiguous frequency channels associated with the first time occasion T1, and P=2 available contiguous frequency channel associated with the second time occasion T2. For example, the transmitter node selects S=4 selected frequency channels, such as S=2 selected contiguous frequency channels associated with the first time occasion T1, and S=2 selected contiguous frequency channel associated with the second time occasion T2. For example, the transmitter node transmits the first part, second part, third part, and the fourth part using S=N=4 time-frequency resources among M=18 allocated resources. In one or more examples, frequency channels 634, 636 associated with the second time occasion T2 can be seen as allocated but unused frequency channels, such as frequency channels not used for transmission of the reference signal. In one or more examples, the unused frequency channels, such as frequency channels 634, 636 associated with the second time occasion T2, can be used by other technologies and/or communication systems (such as, Wi-Fi, Bluetooth, among others).

FIG. 4D shows an example resource configuration 649 for transmission of a reference signal using non-contiguous frequency channels, such as frequency channels associated with at least two time occasions. FIG. 4D shows a similar representation of resource configuration 615 of FIG. 4B. FIG. 4D may differ from FIG. 4B in that a transmission of a reference signal is performed using non-contiguous frequency channels associated with non-contiguous time occasions. In other words, the transmitter node may transmit a first part 662A, a second part 662B of the reference signal using frequency channels 654, 660, such as non-contiguous frequency channels associated with a first time occasion T1. The transmitter node may transmit a third part 662C, a fourth part 662D of the reference signal using frequency channels 656, 650, such as non-contiguous frequency channels associated with a third time occasion T3. In one or more examples, the transmitter does perform any transmission of one or more parts of reference signal at the second time occasion T2. The transmitter node may detect LBT failures 40A, 40B, 40D, 40E associated with the first time occasion T1. In other words, frequency channels 650, 652, 656, 658 may be determined by the transmitter node as frequency channels unavailable for transmission of parts of the reference signal. The transmitter node may detect LBT failures 40A1, 40B1, 40D1, 40E1 associated with the second time occasion T2. In other words, frequency channels 650, 652, 656, 658 may be determined by the transmitter node as frequency channels unavailable for transmission of parts of the reference signal. The transmitter node may detect LBT failures 40B2, 40E2 associated with the third time occasion T3. In other words, frequency channels 652, 658 may be determined by the transmitter node as frequency channels unavailable for transmission of parts of the reference signal. In one or more examples, frequency channels 654, 660, each associated with the second time occasion T2 and the third time occasion T3 can be seen as allocated but unused frequency channels, such as frequency channels not used for transmission of the reference signal. In one or more examples, the unused frequency channels, such as frequency channels 654, 660 associated with the second time occasion T2 and the third time occasion T3, can be used by other technologies and/or communication systems (such as, Wi-Fi, Bluetooth, among others).

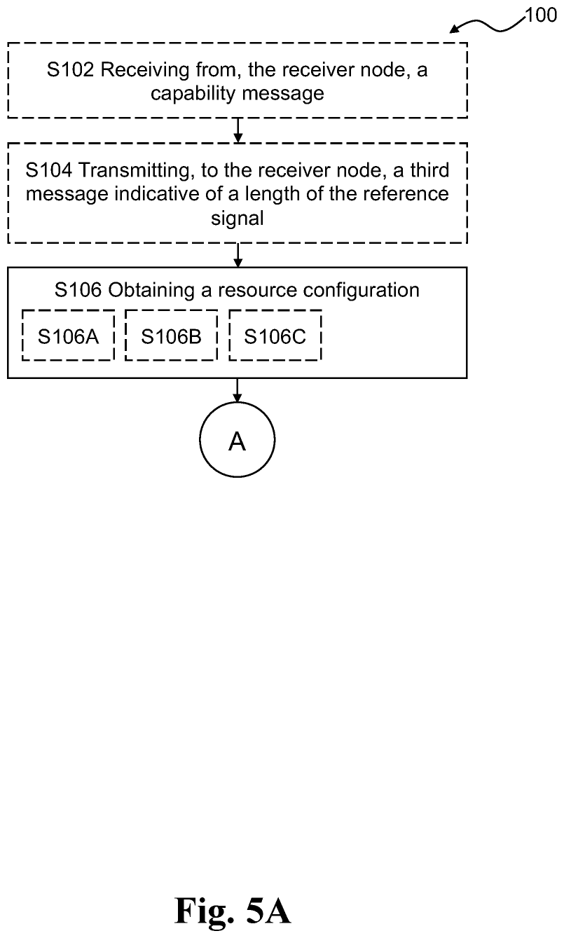

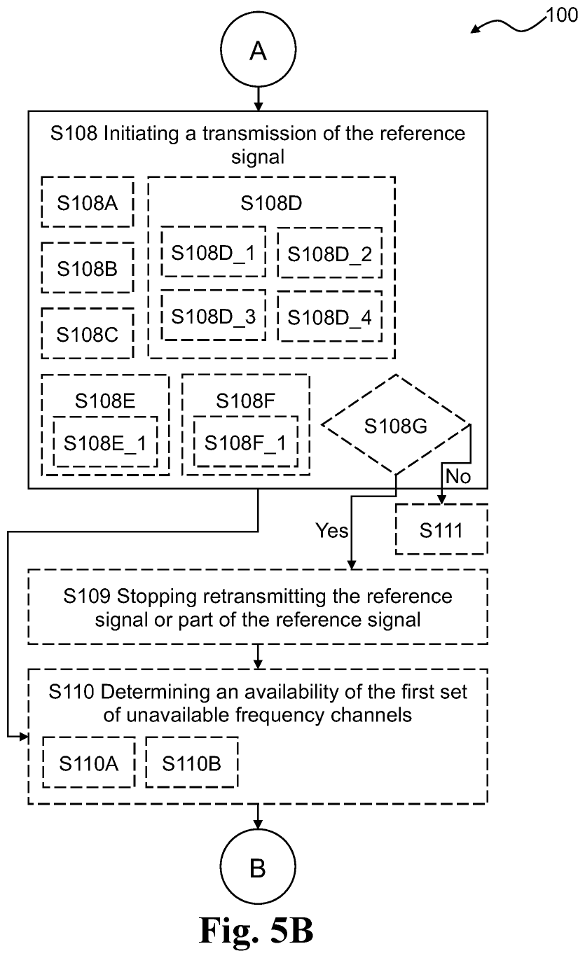

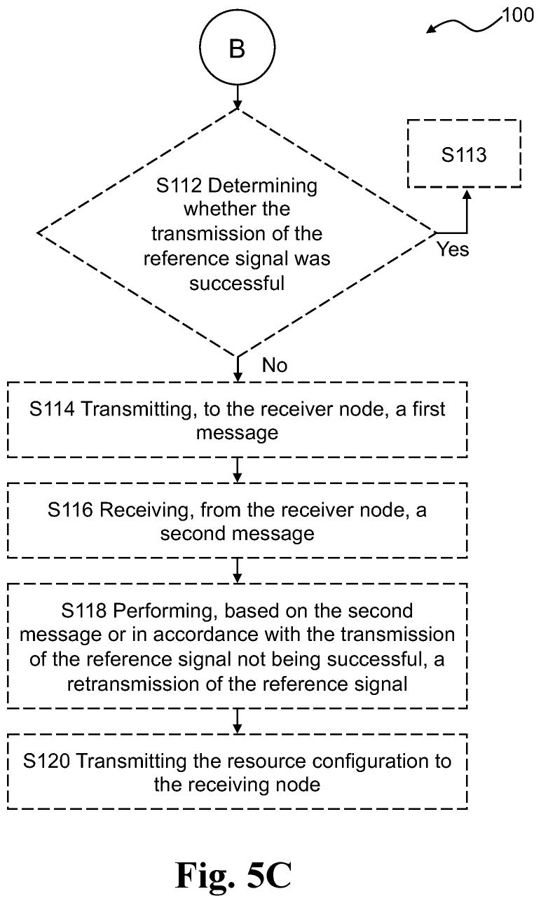

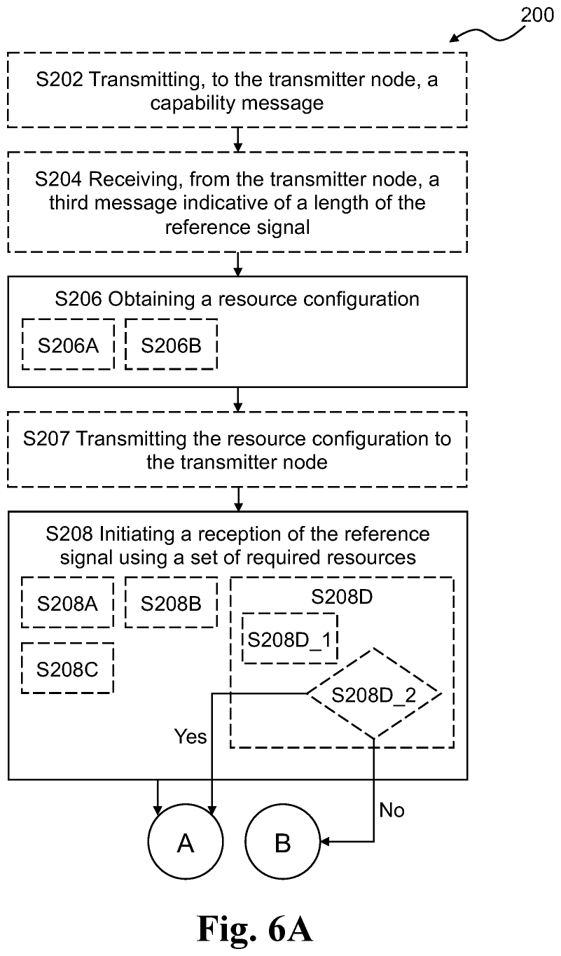

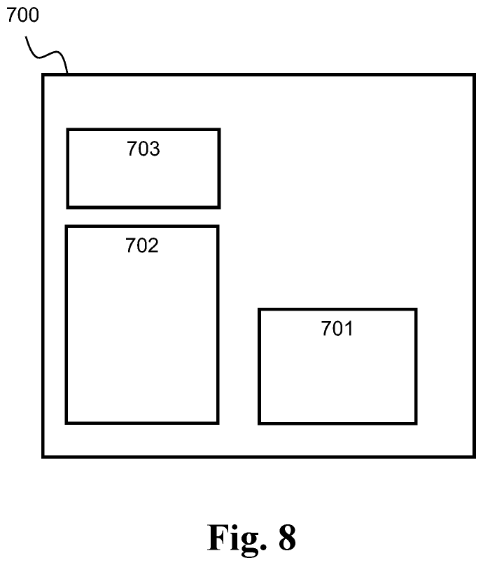

FIGS. 5A-5C show a flow-chart illustrating an example method 100, performed by a transmitter node according to this disclosure, for supporting transmission of a reference signal for positioning in one or more unlicensed frequency bands. The transmitter node is the transmitter node disclosed herein, such as transmitter node 700 of FIG. 8. In one or more example methods, the transmitter node can be one or more of: a wireless device (such as, a first wireless device and/or a second wireless device), a network node, and a network node assisted by a resource allocation node. In one or more examples, the transmitter node may be configured to support transmission of a reference signal for positioning in a contention-based communication.

The method 100 comprises obtaining S106 a resource configuration indicative of a set of allocated resources comprising a first number of frequency channels. In one or more examples, a resource configuration is indicative of a set of frequency channels, such as the first number of frequency channels, over which transmission of a reference signal is scheduled. Each frequency channel of the first number of frequency channels may have an associated number of time occasions. In one or more examples, a time occasion can be construed as a specific time during which the first number of frequency channels can be used to transmit a reference signal. In one or more examples, frequency channels may be seen as frequency sub-bands and/or sub-channels. In one or more examples, the resource configuration indicates a maximum number of frequency channels that can be used for transmission of a reference signal, such as a maximum number of allocated frequency channels that can be used for transmission of a reference signal. The resource configuration can, optionally, be indicative of one or more resource locations, such as one or more locations of the set of allocated resources. For example, the transmitter node may determine, based on the one or more locations, the set of allocated resources. Obtaining a resource configuration may be seen as receiving the resource configuration at the transmitter node from another node, such as a resource allocation node and/or a scheduling node.

In one or more example methods, obtaining S106 the resource configuration comprises obtaining S106A the resource configuration from a resource allocation node via the receiver node. In one or more examples, the transmitter node is a wireless device, such as for an UL-based positioning procedure. In one or more examples, the receiver node is a radio network node, such as a radio network node intended to serve the wireless device. In one or more examples, the receiver node is assisted by the resource allocation node. In other words, the network node forwards the resource configuration to the wireless device from the resource allocation node. For example, a gNB may forward the resource configuration to the wireless device, such as UE, from the resource allocation node, such as LMF. In one or more examples, the network node is the resource allocation node. The network node may transmit, to the wireless device, the resource configuration.

In one or more example methods, obtaining S106 the resource configuration comprises obtaining S106B the resource configuration from a resource allocation node via a coordinating network node. In one or more examples, the transmitter node is a transmitter wireless device and/or a first wireless device, such as for a SL-based positioning procedure. A coordinating network node may be seen as a network node configured to provide resource configuration to the transmitter wireless device. A coordinating network node may be assisted by a resource allocation node. In one or more examples, the coordinating network node is the resource allocation node.

In one or more example methods, obtaining S106 the resource configuration comprises determining S106C the resource configuration at the transmitter node. In one or more examples, the transmitter node is a network node, such as for a DL-based positioning procedure. In one or more examples the transmitter node may be a scheduling node, such as a resource allocating node and/or a network node assisted by a resource allocating node and/or a network node. In one or more example methods, the method 100 comprises transmitting S120 the resource configuration to the receiver node. In one or more examples, the receiver node is a wireless device that is served by the network node.

In one or more example methods, the transmitter node is a wireless device and/or a network node, such as a wireless device and/or a radio network node as disclosed herein.

The method 100 comprises initiating S108 a transmission of the reference signal using a set of required resources, wherein the set of required resources is a subset of the set of allocated resources. In one or more examples, the method 100 comprises initiating a transmission of the reference signal using at least the set of required resources, e.g., if it is possible to use them. In one or more examples, the method 100 comprises initiating a transmission of the reference signal using the set of required resources among the set of allocated resources. In one or more examples, the set of allocated resources is larger than the set of required resources for transmitting the reference signal. In one or more examples, the reference signal may be seen as a first reference signal, such as a first reference signal intended to be transmitted within a certain time window, e.g., a first time window. It may be appreciated that after a certain period of time, such as after the first time window, the transmitter node may initiate transmissions of further reference signals, such as a second reference signal, a third reference signal etc. The technique disclosed herein may also be applicable to the transmission and reception of further reference signals.

In one or more example methods, the set of required resources comprises a second number of frequency channels. In one or more example methods, the first number of frequency channels is greater than the second number of frequency channels. In one or more examples, the set of required resources for transmitting the reference signal is a subset of the set of allocated resources in frequency domain. In one or more examples, the set of allocated resources are associated with a single time occasion. In one or more example methods, initiating S108 a transmission of the reference signal comprises initiating S108A a transmission of the reference signal using the second number of frequency channels among the first number of frequency channels. In one or more examples, the second number of frequency channels can be seen as a number of required frequency channels to be used for transmission of the reference signal. In one or more examples, the first number of frequency channels can be seen as a number of allocated frequency channels that can be used for transmission of the reference signal. The present disclosure provides resource configurations where a set of allocated resources provide additional resources in the frequency domain compared to the set of required resources in frequency domain for transmitting a reference signal. In one or more examples, resource configurations where the set of allocated resources provide additional resources in the frequency domain are illustrated in FIGS. 2A-2C.

In one or more examples, the set of allocated resources comprises a first number of time occasions and the set of required resources comprises a second number of time occasions. In one or more examples, the first number of time occasions is greater than or equal to the second number of time occasions. In one or more examples, a time occasion can be seen as a specific time during which a set of frequency channels can be used to transmit a reference signal. In one or more examples, the first number of time occasions comprises one or more first time occasions. Put differently, the first number of time occasions may be indicative of a time window. In one or more examples, a time window can be seen as a period of time during which the transmitter node is expected to transmit the reference signal. In one or more examples, the set of required resources for transmitting the reference signal is a subset of the set of allocated resources in time domain. In one or more examples, each resource of the set of allocated resources is associated with at least two time occasions. In one or more example methods, initiating S108 a transmission of the reference signal comprises initiating S108B a transmission of the reference signal using the second number of time occasions among the first number of time occasions. In one or more examples, the second number of time occasions can be seen as a number of required time occasions during which a set of required resources can be used for transmission of the reference signal. In one or more examples, the first number of time occasions can be seen as a number of allocated time occasions during which a set of allocated resources can be scheduled to transmit the reference signal. The present disclosure provides resource configurations where a set of allocated resources provide additional resources in the time domain compared to the set of required resources in the time domain for transmitting a reference signal. In one or more examples, resource configurations where the set of allocated resources provide additional resources in the time domain are illustrated in FIG. 3.

In one or more examples, the set of allocated resources comprises a first number of time-frequency resources and the set of required resources comprises a second number of time-frequency resources. In one or more examples, the set of allocated resources is associated with at least two time occasions. In one or more examples, the first number of time-frequency resources is greater than the second number of time-frequency resources. In one or more examples, the first number of time-frequency resources is greater than or equal to the second number of time-frequency resources. In one or more examples, the first number of time-frequency resources may comprise a number of allocated frequency channels being smaller or equal to a number of required frequency channels of the second number of time-frequency resources. In one or more examples, the first number of time-frequency resources may comprise a number of allocated time occasions being smaller or equal to a number of required time occasions of the second number of time-frequency resources.

In one or more example methods, initiating S108 a transmission of the reference signal comprises initiating S108C a transmission of the reference signal using the second number of time-frequency resources among the first number of time-frequency resources. In one or more examples, the first number of time-frequency resources may be indicative of a set of allocated frequency channels and/or a set of allocated time occasions over which transmission of a reference signal is scheduled. In one or more examples, the second number of time-frequency resources may be indicative of a set of required frequency channels and/or a set of required time occasions over which transmission of a reference signal can be performed. The present disclosure provides resource configurations where a set of allocated resources provide additional resources in the time-frequency domain compared to the required resources in time-frequency domain for transmitting a reference signal. In other words, a resource configuration with additional resources in the time-frequency domain may be indicative of a set of allocated frequency channels and/or a set of allocated time occasions over which transmission of a reference signal is scheduled. In one or more examples, resource configurations where the set of allocated resources provide additional resources in the time-frequency domain are illustrated in FIG. 4A-4D.

In one or more example methods, initiating S108 a transmission comprises determining S108D an availability of the first number of frequency channels at a first time occasion. In one or more example methods, determining S108D an availability of the first number of frequency channels comprises performing S108D_1 a first LBT procedure on the first number of frequency channels. In one or more examples, performing the first LBT procedure of the first number of frequency channels comprises monitoring each frequency channel of the first number of frequency channels. In one or more examples, performing the first LBT procedure of the first number of frequency channels comprises performing a CCA on each frequency channel of the first number of frequency channels. In one or more example methods, determining S108D an availability of the first number of frequency channels comprises determining S108D_2, based on the first LBT procedure, a first set of available frequency channels at the first time occasion. In one or more examples, an available frequency channel of the first set of available frequency channel can be seen as an LBT channel, such as with a size of nominal channel bandwidth (NCB) of 20 MHz. In one or more examples, an LBT channel can be construed as a channel where the transmitter node can transmit the reference signal, such as within such channel, with the transmitter node performing an LBT mechanism and/or procedure prior to the transmission. In one or more example methods, initiating S108 a transmission comprises transmitting S108E the reference signal or a first part of the reference signal using the first set of available frequency channels at the first time occasion. In one or more examples, the transmitter node performs a first transmission attempt of the reference signal or a first part of the reference signal using the first set of available frequency channels at the first time occasion.

In one or more example methods, determining S108D an availability of the first number of frequency channels comprises detecting S108D_3 a first LBT failure. In one or more examples, when the transmitter node detects that another node or device is transmitting on one or more frequency channels of the first number of frequency channels, this may be seen as an LBT failure detected on such frequency channels. In one or more example methods, determining S108D an availability of the first number of frequency channels comprises determining S108D_4, based on the first LBT failure, a first set of unavailable frequency channels at the first time occasion. In one or more examples, a set of unavailable frequency channels may be seen as a set of frequency channels that cannot used to transmit the reference signal or a first part of the reference signal as such channels may already being used by another node or device.

In one or more example methods, when the first part has been transmitted, the method comprises determining S110 an availability of the first set of unavailable frequency channels at a second time occasion. In one or more example methods, determining S110 an availability of the first set of unavailable frequency channels at a second time occasion comprises performing S110A a second LBT procedure on the first set of unavailable frequency channels. In one or more examples, performing the second LBT procedure on the first set of unavailable frequency channels comprises performing the second LBT procedure on each unavailable frequency channels of the first set of unavailable frequency channels. In one or more examples, performing the second LBT procedure on the first set of unavailable frequency channels comprises performing a CCA on each unavailable frequency channels of the first set of unavailable frequency channels.

For example, there may be a temporal aspect in that the CCA procedure has an element of randomness which may result in different durations for each of the first set of unavailable frequency channels. For example, a second LBT procedure performed on a first frequency channel of first set of unavailable frequency channels may start earlier and/or later than a second LBT procedure performed on a second frequency channel of first set of unavailable frequency channels. The transmitter node may be configured to continuously perform a second LBT procedure on each unavailable frequency channels of the first set of unavailable frequency channels until the transmitter node detects one or more unavailable frequency channels of the first set of unavailable frequency channels as available to be used for transmission of the reference signal or a part of the reference signal. For example, the transmitter node may transmit signals, such as different from the reference signal, to fill in a gap between a successful CCA and a time (such as, a time occasion) to transmit the reference signal or a part of the reference signal. In one or more example methods, determining S110 an availability of the first set of unavailable frequency channels at a second time occasion comprises determining S110B, based on the second Listen Before Talk (LBT) procedure, a second set of available frequency channels at the second time occasion.

In one or more example methods, initiating S108 a transmission comprises transmitting S108F a second part or remaining part of the reference signal using the second set of available frequency channels at the second time occasion. In one or more examples, initiating a transmission comprises transmitting a third part of the reference signal using a third set of available frequency channels at a third time occasion.

In one or more example methods, the method 100 comprises determining S112 whether the transmission of the reference signal was successful. In one or more example methods, in accordance with the transmission of the reference signal being successful, the method 100 comprises determining S113 that the transmission of the reference signal was successful.

In one or more example methods, in accordance with the transmission of the reference signal not being successful, the method 100 comprises transmitting S114, to the receiver node, a first message indicative of the failure in the transmission of the reference signal and/or a part of the reference signal. In one or more examples, the first message may be indicative of the failure in the transmission of the reference signal and/or a part of the reference signal. In one or more examples, the first message indicates an LBT failure. In one or more examples, the LBT failure can be indicated by the transmission node by explicit signaling. The explicit signaling may be transmitted on the same slot where the reference signal or a part of the reference signal is transmitted. The explicit signaling may be transmitted on a later slot than the slot where reference signal or a part of the reference signal is transmitted. In one or more examples, the explicit signaling can be indicated by the resource configuration. For example, the explicit signaling can be carried by Sidelink Control Information (SCI). For example, the transmitter node intends to transmit the reference signal using a number of contiguous frequency channels associated, for example, with a single time occasion. The transmission of the reference signal may fail when less than such number of contiguous channels are available. In one or more examples, the transmitter node can stop the transmission of the reference signal, optionally signaling the receiver node about such stopped transmission.

In one or more example methods, the method 100 comprises receiving S116, from the receiver node, a second message indicative of a reception failure of the reference signal and/or a part of the reference signal. In one or more examples, the second message indicative of a reception failure of the reference signal and/or a part of the reference signal, such as a first part, a second part, a third part, etc., of the reference signal. In one or more examples, the second message indicative of a reception failure of the reference signal and/or a part of the reference signal on a set of available frequency channels, such as a first, a second, a third set of available frequency channels, at a time occasion, such as at a first, a second, a third time occasion.

In one or more examples, the transmitter node is a transmitter wireless device, and the receiver node is a receiver wireless device. The transmitter wireless device may receive, from the receiver wireless device, the second message via the coordinating network node.

In one or more examples, the second message can be indicative of a request for additional resources arranged in time and/or frequency domains. For example, the transmitter node is able to transmit, to the receiver node, a first part, a second part, and a third part of the first reference signal on a first reference signal transmission attempt. The receiver node may perform unsatisfactory positioning measurements based on the first part, the second part, and the third part of the first reference signal. Optionally, the receiver node may detect one or more additional resources leading to unsatisfactory positioning measurements, such as due to the interference. In one or more example methods, the second message is indicative of an unsatisfactory positioning measurement performed by the receiver node based on the reference signal.

In one or more example methods, the method 100 comprises performing S118, based on the second message or in accordance with the transmission of the reference signal not being successful, a retransmission of the reference signal or a part of the reference signal to the receiver node. In one or more examples, the method 100 comprises, in response to receiving the second message or in response to determine a failure in the transmission of the reference signal, performing a retransmission and/or one or more retransmissions of the reference signal or a part of the reference signal to the receiver. In one or more examples, the retransmission of the reference signal or a part of the reference signal can be performed at a next time occasion, such as at a contiguous time occasion and/or a non-contiguous time occasion.

In one or more example methods, transmitting S108E the reference signal or the first part comprises transmitting S108E_1 using one or more of: contiguous frequency channels (such as, frequency channels among the first number of frequency channels) associated with one or more time occasions, and non-contiguous frequency channels associated with one or more time occasions. In one or more example methods, transmitting S108F the second part of the reference signal comprises transmitting S108F_1 using one or more of: contiguous frequency channels (such as, frequency channels among the first number of frequency channels) associated with one or more time occasions, and non-contiguous frequency channels associated with one or more time occasions. In one or more examples, contiguous frequency channels associated with one or more time occasions may be illustrated in FIGS. 2A-2C, FIG. 3, FIG. 4A, and FIG. 4C. In one or more examples, non-contiguous frequency channels associated with one or more time occasions may be illustrated in FIG. 4B, and FIG. 4D.

In one or more example methods, initiating S108 a transmission comprises determining S108G whether a transmission of the reference signal or part of the reference signal satisfies a stop criterion. In one or more examples, initiating a transmission comprises determining that a transmission of the reference signal or part of the reference signal satisfies a stop criterion. In one or more examples, in accordance with the transmission not satisfying the stop criterion, the method 100 comprises performing S111 a retransmission of the reference signal or a part of the reference signal to the receiver node. In one or more example methods, in accordance with the transmission satisfying the stop criterion, the method 100 comprises stopping S109 retransmitting the reference signal or part of the reference signal. In one or more examples, the stop criterion is based on one or more of: a length of the reference signal, and a channel occupancy time (COT) length, such as a COT parameter indicative of a length and/or duration of a COT and/or a time window duration.

For example, the present disclosure may allow overcoming an LBT failure by repeating the transmission of the reference signal in the time domain, such as during a time window. The transmitter node may perform CCA on a number of frequency channels, such as on a first number of frequency channels. On the successful ones, the transmitter node may transmit a corresponding part of the reference signal. On the unsuccessful ones, the transmitter node may perform CCA again, until it eventually succeeds, or the COT runs out. For example, the transmitter node repeat transmissions of the reference signal or a part of the reference signal until a stop criterion is fulfilled:
Transmissions of the reference signal stop as soon as the entire reference signal has been transmitted, such as an N-long reference signal. Such transmission mode may be suitable for receivers that cannot perform frequency combining, such as that cannot combine a plurality of parts of the reference signal for provision of a reconstructed reference signal. Resource allocations suitable for such transmission mode may be illustrated in FIGS. 2A-2C and FIG. 4A, and FIGS. 4C-4D. In other words, the transmitter may determine whether the reference signal has been transmitted entirely.
Transmissions of the reference signal stop independently on each frequency channel of the number of frequency channels as soon as the corresponding part of the reference signal has been transmitted. Such transmission mode may be suitable for receivers capable of performing frequency combining procedures. Resource allocations suitable for such transmission mode may be illustrated in FIGS. 4B-4D.
All transmissions cease when the COT is finished, which may indicate a failure in the transmission of the reference signal.

In one or more examples, the transmitter node may stop transmission of the reference signal, when the reference signal has been transmitted in its entirety and/or when the maximum number of time domain resources is reached (such as, when the maximum number of time occasions, each time occasion being associated with a number of frequency channels is reached), and/or when the COT length of each available frequency channel runs out.

In one or more examples, the transmitter node determines that there is a failure in the transmission of the reference signal when a transmission of a part of the reference signal in a respective frequency channel is not completed and/or when a measurement position is not satisfactory and/or when the channel occupancy time (COT) of each available frequency channel runs out. In one or more examples, the transmitter node determines that the transmission of the reference signal is a success when all parts and/or portions of the reference signal are transmitted over a number of required channels, such as on a second number of frequency channels.

In one or more example methods, the method 100 comprises receiving S102 from, the receiver node, a capability message indicative of a capability of the receiver node to perform frequency combining of a received reference signal or of parts of the reference signal at one or more time occasions. In one or more example methods, the capability message comprises a maximum time span indicative of a time within which frequency combining can be performed. In one or more examples, a maximum time span may correspond to a time window comprising one or more time occasions during which a set of frequency channels can be used to transmit the reference signal or a part of the reference signal. The time window can comprise a first time occasion, a second time occasion, a third time occasion, etc. For example, different maximum time spans may correspond to different wireless devices categories.

In one or more examples, a frequency combining procedure is a procedure to aggregate the received reference signal in multiple frequency channels, such as to aggregate a plurality of parts of the reference signal that are received in respective frequency channels. In one or more examples, the aggregation of the plurality of parts of the reference signal can be performed simultaneously at the same time occasion (such as, when using contiguous frequency channels for the transmission) and/or at different time occasions (such as, when using non-contiguous frequency channels for the transmission). In one or more examples, the frequency combining procedure may involve frequency stitching, in which there is a phase correction between two adjacent frequency channels.

In one or more example methods, the method 100 comprises transmitting S104, to the receiver node, a third message indicative of a length, such as a size, of the reference signal, such as a length defined as the number of frequency channels required to transmit the reference signal, such as the second number of frequency channels. In one or more examples, obtaining the resource configuration can comprise transmitting, to the receiver node, the third message. For example, the transmitter node is a wireless device or a transmitter device, whereas the receiver node is a network node or a receiver wireless device. A resource allocating node may determine the resource configuration based on the length of the reference signal. It may be appreciated that obtaining a resource configuration S106 may comprise transmitting S104 the third message.

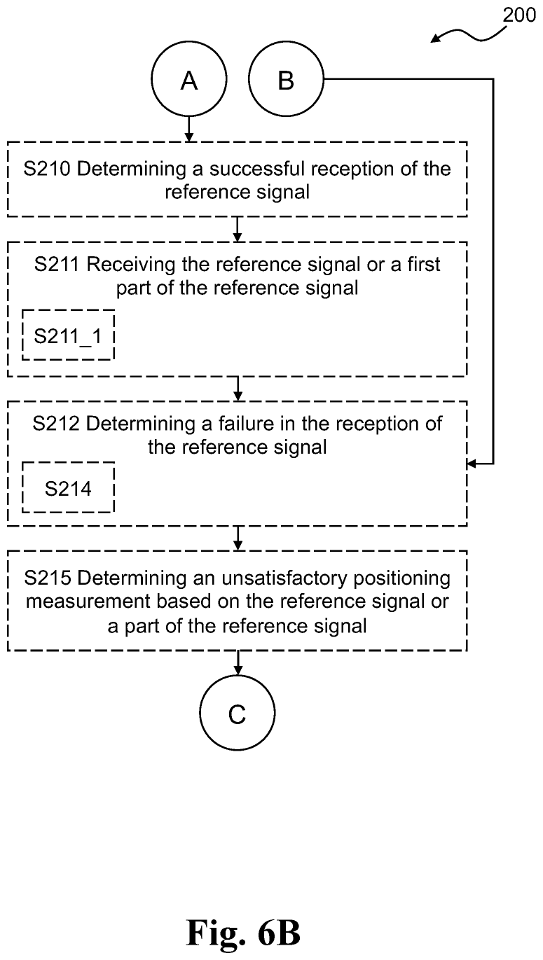

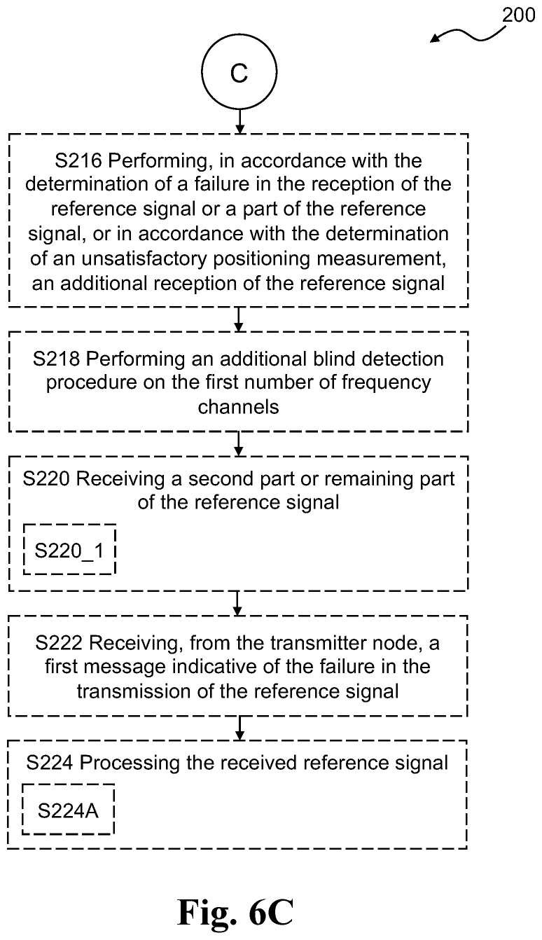

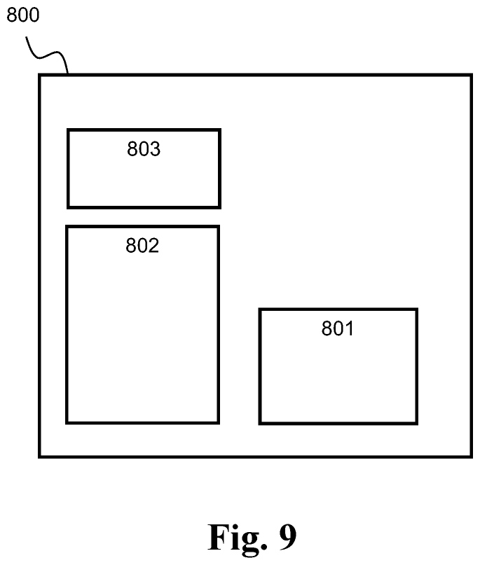

FIGS. 6A-6C show a flow-chart illustrating an example method 200, performed by a receiver node according to this disclosure, for supporting reception of a reference signal for positioning in one or more unlicensed frequency bands. The receiver node is the receiver node disclosed herein, such as receiver node 800 of FIG. 9. In one or more example methods, the receiver node can be one or more of: a wireless device, a receiver wireless device, a network node, a network node assisted by a resource allocation node. In one or more examples, the resource allocation node can be an LMF for a DL-TDOA positioning procedure. In one or more examples, the resource allocation node can be a network node, such as for an UL-TDOA positioning procedure. In one or more examples, the receiver node may be configured to support reception of a reference signal for positioning in a contention-based communication.

The method 200 comprises obtaining S206 a resource configuration indicative of a set of allocated resources comprising a first number of frequency channels. In one or more examples, a resource configuration is indicative of a set of frequency channels, such as the first number of frequency channels, over which reception of a reference signal is scheduled. Each frequency channel of the first number of frequency channels may have an associated number of time occasions. In one or more examples, a time occasion can be construed as a specific time during which the first number of frequency channels can be used to receive a reference signal. In one or more examples, frequency channels may be seen as frequency sub-bands and/or sub-channels. In one or more examples, the resource configuration indicates a maximum number of frequency channels that can be used for reception of a reference signal. The resource configuration can, optionally, be indicative of one or more resource locations, such as one or more locations of the set of allocated resources. For example, the receiver node may determine, based on the one or more locations, the set of allocated resources.

In one or more example methods, obtaining S206 the resource configuration comprises obtaining S206A the resource configuration from a resource allocation node. In one or more example methods, the method 200 comprises transmitting S207 the resource configuration to the transmitter node. In one or more examples, the transmitter node is a network node, such as for an UL-based positioning procedure. In one or more examples, the receiver node is a wireless device, with the network node being intended to serve the wireless device. In one or more examples, the receiver node is assisted by the resource allocation node. In other words, the network node forwards the resource configuration to the wireless device from the resource allocation node. In one or more examples, the network node is the resource allocation node. The network node may transmit, to the wireless device, the resource configuration.

In one or more example methods, obtaining S206 the resource configuration comprises obtaining S206B the resource configuration from a resource allocation node via one or more of: the transmitter node or a coordinating network node. In one or more examples, the receiver node is a receiver wireless device and/or a second wireless device, such as for a SL-based positioning procedure. A coordinating network node may be seen as a network node configured to provide resource configuration to the transmitter wireless device and/or the receiver wireless device. A coordinating network node may be assisted by a resource allocation node. In one or more examples, the receiver node is a wireless device and the transmitter node is a network node, such as for an DL-based positioning procedure. In one or more examples, the resource allocation node is the network node and/or the coordinating network node.

In one or more example methods, the receiving node is a wireless device and/or a network node, such as a wireless device and/or radio network node as disclosed herein.

The method 200 comprises initiating S208 a reception of the reference signal using a set of required resources, wherein the set of required resources is a subset of the set of allocated resources. In one or more examples, the method 200 comprises initiating a reception of the reference signal using at least the set of required resources. In one or more examples, the method 200 comprises initiating a reception of the reference signal using the set of required resources among the set of allocated resources. In one or more examples, the set of allocated resources is larger than the set of required resources for receiving the reference signal. In one or more examples, the reference signal may be seen as a first reference signal.

In one or more example methods, the set of required resources comprises a second number of frequency channels. In one or more example methods, the first number of frequency channels is greater than the second number of frequency channels. In one or more examples, the set of required resources for receiving the reference signal is a subset of the set of allocated resources in frequency domain. In one or more examples, the set of allocated resources are associated with a single time occasion. In one or more example methods, initiating S208 a reception of the reference signal comprises initiating S208A a reception of the reference signal using the second number of frequency channels among the first number of frequency channels. In one or more examples, the second number of frequency channels can be seen as a number of required frequency channels to be used for reception of the reference signal. In one or more examples, the first number of frequency channels can be seen as a number of allocated frequency channels that can be used for reception of the reference signal. The present disclosure provides resource configurations where a set of allocated resources provide additional resources in the frequency domain compared to the set of required resources in frequency domain for receiving a reference signal. In one or more examples, resource configurations where the set of allocated resources provide additional resources in the frequency domain are illustrated in FIGS. 2A-2C.

In one or more example methods, the set of allocated resources comprises a first number of time occasions and the set of required resources comprises a second number of time occasions. In one or more example methods, the first number of time occasions is greater than the second number of time occasions. In one or more examples, a time occasion can be seen as a specific time during which a set of frequency channels can be used to receive a reference signal. In one or more examples, the first number of time occasions comprises one or more first time occasions. Put differently, the first number of time occasions may be indicative of a Time Window. In one or more examples, a Time Window can be seen as a period of time during which the receiver node is expected to receive the reference signal. In one or more examples, the set of required resources for receiving the reference signal is a subset of the set of allocated resources in time domain. In one or more examples, each resource of the set of allocated resources is associated with at least two time occasions. In one or more example methods, initiating S208 a reception of the reference signal comprises initiating S208B a reception of the reference signal using the second number of time occasions among the first number of time occasions. In one or more examples, the second number of time occasions can be seen as a number of required time occasions during which a set of required resources can be used for reception of the reference signal. In one or more examples, the first number of time occasions can be seen as a number of allocated time occasions during which a set of allocated resources can be scheduled to receive the reference signal. The present disclosure provides resource configurations where a set of allocated resources provide additional resources in the time domain compared to the set of required resources in time domain for transmitting a reference signal. In one or more examples, resource configurations where the set of allocated resources provide additional resources in the time domain are illustrated in FIG. 3.

In one or more example methods, the set of allocated resources comprises a first number of time-frequency resources and the set of required resources comprises a second number of time-frequency resources. In one or more example methods, the first number of time-frequency resources is greater than the second number of time-frequency resources. In one or more examples, the set of allocated resources is associated with at least two time occasions. In one or more example methods, initiating S208 a reception of the reference signal comprises initiating S208C a reception of the reference signal using the second number of time-frequency resources among the first number of time-frequency resources. In one or more examples, the first number of time-frequency resources may be indicative of a set of allocated frequency channels and/or a set of allocated time occasions over which reception of a reference signal is scheduled. In one or more examples, the second number of time-frequency resources may be indicative of a set of required frequency channels and/or a set of required time occasions over which reception of a reference signal can be performed. The present disclosure provides resource configurations where a set of allocated resources provide additional resources in the time-frequency domain compared to the required resources in time-frequency domain for receiving a reference signal. In other words, a resource configuration with additional resources in the time-frequency domain may be indicative of a set of allocated frequency channels and/or a set of allocated time occasions over which reception of a reference signal is scheduled. In one or more examples, resource configurations where the set of allocated resources provide additional resources in the time-frequency domain are illustrated in FIG. 4A-4D.

In one or more example methods, initiating S208 a reception comprises performing S208D a blind detection procedure on the first number of frequency channels, such as at a first time occasion. In one or more examples, the receiver node can perform blind detection procedure to determine whether there is a transmission of the reference signal in a given frequency channel. In one or more example methods, performing S208D a blind detection procedure comprises detecting S208D_1 a reception power level on the first number of frequency channels, such as at a first time occasion. In one or more examples, the reception power level is associated with the reception of the reference signal or part of the reference signal. In one or more example methods, performing S208D a blind detection procedure comprises determining S208D_2 whether the reception power level satisfies a reception criterion. In one or more examples, the receiver node determines that the reception power level satisfies the reception criterion when the reception criterion is greater than or equal to a reception threshold. In one or more examples, upon determining that the reception power level satisfies a reception criterion, the receiver node detects reception of the reference signal or a part of the reference signal on a frequency channel of the first number of frequency channels. In one or more examples, the receiver node determines that the reception power level does not satisfy the reception criterion when the reception criterion is less than the reception threshold. In one or more examples, upon determining that the reception power level does not satisfy a reception criterion, the receiver node does not detect a reception of the reference signal or of a part of the reference signal on a frequency channel of the first number of frequency channels. In other words, the receiver node may detect that the transmitter node does not transmit the intended reference signal for positioning, which may be due to an LBT failure.

In one or more example methods, the method 200 comprises determining S210 a successful reception of the reference signal or a part of the reference signal on one or more of the first number of frequency channels, such as a first set of available frequency channels at the first time occasion. In one or more example methods, the method 200 comprises receiving S211 the reference signal or a first part of the reference signal using a first set of available frequency channels at a first time occasion. In one or more examples, determining S210 a successful reception of the reference signal comprises receiving the reference signal or a part of the reference signal, such as a first part of the reference signal, using the first set of available frequency channels at the first time occasion.

In one or more example methods, the method 200 comprises determining S215 an unsatisfactory positioning measurement based on the reference signal or a part of the reference signal. For example, a received reference signal, such as a received PRS resource, on a first transmission attempt may not be sufficient for performing positioning estimation (e.g., poor positioning measurement results) and/or the receiver node may detect that one or more resource used to receive the reference signal or part of reference signal result in poor positioning measurement results (e.g., due to the interference).

In one or more example methods, in accordance with the reception power level not satisfying the reception criterion, the method 200 comprises determining S212 a failure in the reception of the reference signal or a part of the reference signal on one or more of the first number of frequency channels, such as a first set of unavailable frequency channels at the first time occasion.

In one or more example methods, in accordance with the determination S212 of a failure in the reception of the reference signal or part of the reference signal, the method comprises transmitting S214, to the transmitter node, a second message indicative of a reception failure of the reference signal or a part of the reference signal. In one or more examples, the receiver node transmits the second message received in S116 of FIGS. 5A-5C. In one or more examples, the second message can comprise a request for additional resources, such as for compensating the unsatisfactory positioning measurement. In one or more example methods, the second message be indicative of an unsatisfactory positioning measurement.

In one or more example methods, the method 200 comprises performing S216, in accordance with the determination S212 of a failure in the reception of the reference signal or a part of the reference signal, or in accordance with the determination of an unsatisfactory positioning measurement, an additional reception of the reference signal or a part of the reference signal from the transmitter node. In one or more examples, the additional reception of the reference signal or a part of the reference signal is in response to the retransmission performed in S118 of FIGS. 5A-5C.

In one or more example methods, the method 200 comprises performing S218 an additional blind detection procedure on the first number of frequency channels, such as on a second set of available frequency channels at a second time occasion.

In one or more example methods, the method 200 comprises receiving S220 a second part or remaining part of the reference signal using a second set of available frequency channels at a second time occasion.

In one or more example methods, the method 200 comprises receiving S222, from the transmitter node, a first message indicative of the failure in the transmission of the reference signal or a part of the reference signal. In one or more examples, the receiver node receives the first message transmitted in S114 of FIGS. 5A-5C.

In one or more example methods, receiving S211 the reference signal or the first part comprises receiving S211_1 using one or more of: contiguous frequency channels associated with one or more time occasions, and non-contiguous frequency channels associated with one or more time occasions. In one or more example methods, receiving S220 the second part of the reference signal comprises receiving S220_1 using one or more of: contiguous frequency channels associated with one or more time occasions, and non-contiguous frequency channels associated with one or more time occasions.

In one or more example methods, the method 200 comprises processing S224 the received reference signal. In one or more examples, the method 200 comprises processing one or more parts of the received reference signal.

In one or more example methods, the method 200 comprises transmitting S202, to the transmitter node, a capability message indicative of a capability of the receiver node to perform frequency combining of a received reference signal or of parts of the reference signal at one or more time occasions. In one or more examples, the receiver node transmits the capability message received in S102 of FIGS. 5A-5C.

In one or more example methods, processing S224 the received reference signal comprises applying S224A a frequency combining procedure to the first part of the reference signal, the second part of the reference signal, and/or a remaining part of the reference signal. In one or more examples, applying a frequency combining procedure to the first part of the reference signal, the second part of the reference signal, and/or a remaining part of the reference signal comprises combining the first part of the reference signal, the second part of the reference signal, and/or a remaining part of the reference signal for provision of a reconstructed reference signal. For example, the receiver node combines a plurality of parts of the reference signal (such as, the first and second part) transmitted using a set of available frequency channels (such as, the first and second set of available frequency channels) at different time occasions (such as, at a first and second time occasion).

In one or more examples, a frequency combining procedure is a procedure to aggregate the received reference signal in multiple frequency channels, such as to aggregate several parts of the reference signal that are received in respective frequency channels. In one or more examples, the aggregation of the several parts of the reference signal can be performed simultaneously at the same time occasion and/or at different time occasions. For example, the receiver node may combine the several parts of the reference signal, with one or more of the several parts of the reference signal being received in different time occasions, such as using non-contiguous frequency channels. For example, the receiver node may combine the several parts of the reference signal, with the several parts of the reference signal being received in the same time occasion, such as using contiguous frequency channels. In one or more examples, the frequency combining procedure may involve frequency stitching, in which there is a phase correction between two adjacent frequency channels.

In one or more examples, the capability message comprises a maximum time span indicative of a time within which frequency combining can be performed. In one or more examples, the maximum time span can be seen as a time window, such as time window T of FIGS. 3-4D. In one or more examples, the maximum time span can be seen as a time window comprising one or more time occasions during which a set of frequency channels can be used to transmit the reference signal or a part of the reference signal. The time window can comprise a first time occasion, a second time occasion, a third time occasion, etc. For example, different maximum time spans may correspond to different wireless devices categories.

In one or more example methods, receiving S204, from the transmitter node, a third message indicative of a length of the reference signal. In one or more examples, the receiver node receives the third message transmitted in S104 of FIGS. 5A-5C.

In one or more example methods, the resource configuration is based on one or more of: the capability message and the third message.

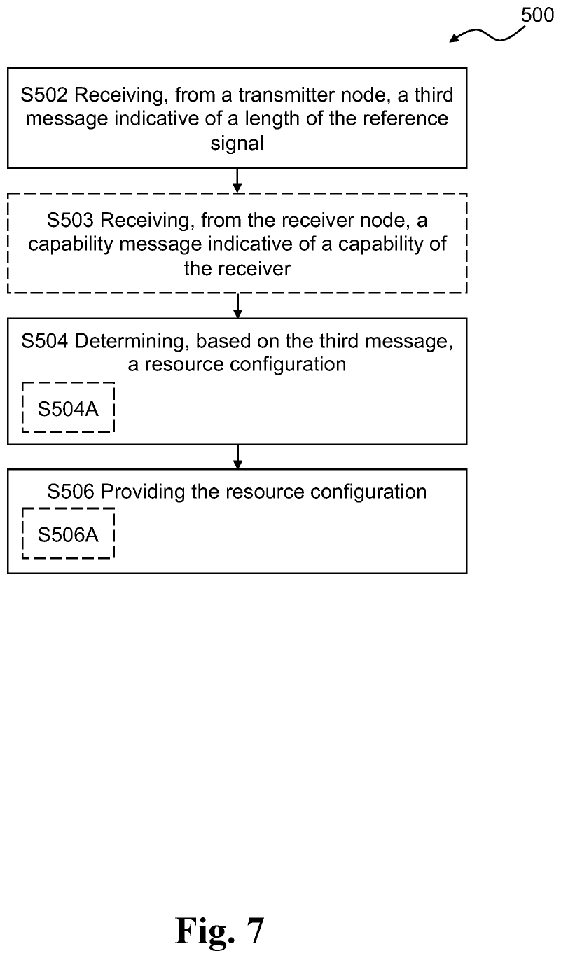

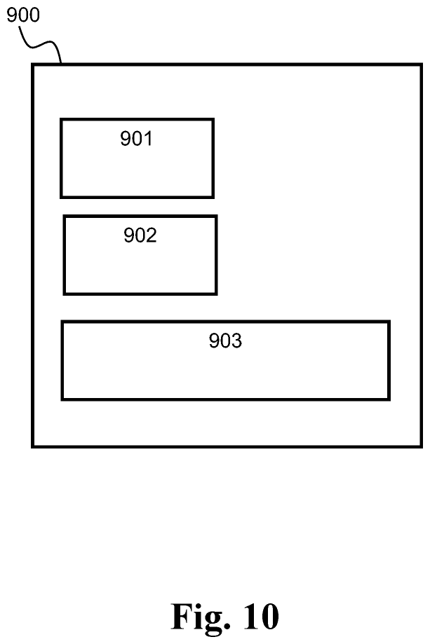

FIG. 7 shows a flow-chart illustrating an example method 500, performed by a resource allocation node according to this disclosure, for supporting transmission and/or reception of a reference signal for positioning in one or more unlicensed frequency bands. In other words, the method 500 may be for facilitating transmission and/or reception of a reference signal for positioning in one or more unlicensed frequency bands. The resource allocation node is the resource allocation node disclosed herein, such as resource allocation node 900 of FIG. 10. In one or more examples, a resource allocation node can be one or more of: a network node, a network node assisted by an LMF and/or a CN, a coordinating network node, a coordinating network node assisted by an LMF and/or a CN, a radio network node, and a wireless device. In one or more examples, a resource allocation node may be seen as a scheduling node and/or a resource management node.

The method 500 comprises receiving S502, from a transmitter node, a third message indicative of a length of the reference signal. In one or more examples, the resource allocating node receives the third message transmitted in S104 of FIGS. 5A-5C. The method 500 comprises determining S504, based on the third message, a resource configuration indicative of a set of allocated resources comprising a first number of frequency channels, wherein a transmission of the reference signal requires a set of required resources and wherein the set of required resources is a subset of the set of allocated resources. The method 500 comprises providing S506 the resource configuration.

In one or more example methods, providing S506 the resource configuration comprises providing S506A the resource configuration to one or more of: a transmitter node, a receiver node, and a coordinating network node. In one or more examples, the resource allocation node provides the resource configuration via one or more of: a transmitter node, a receiver node, and a coordinating network node.

In one or more example methods, the method 500 comprises receiving S503, from the receiver node, a capability message indicative of a capability of the receiver node to perform frequency combining of a received reference signal or of parts of the reference signal at one or more time occasions. In one or more examples, the resource allocating node receives the capability message transmitted in S202 of FIGS. 6A-6C. In one or more example methods, determining S504 a resource configuration comprises determining S504A a resource configuration based on the capability message.

FIG. 8 shows a block diagram of an example transmitter node 700 according to the disclosure. The transmitter node 700 comprises memory circuitry 701, processor circuitry 702, and a wireless interface 703. The transmitter node 700 may be configured to perform any of the methods disclosed in FIGS. 5A-5C. In other words, the transmitter node 700 may be configured for supporting transmission of a reference signal for positioning in one or more unlicensed frequency bands. In one or more example embodiments, the transmitter node 700 can be one or more of: a wireless device (such as, a first wireless device 300 and/or a second wireless device 300A), a network node (such as network node 400, 400A), and a network node assisted by a resource allocation node (such as CN 600).

The transmitter node 700 is configured to obtain (such as via the wireless interface 703) a resource configuration indicative of a set of allocated resources comprising a first number of frequency channels.

The transmitter node 700 is configured to initiate (such as via the processor circuitry 702) a transmission of the reference signal using a set of required resources, wherein the set of required resources is a subset of the set of allocated resources.

The wireless interface 703 is configured for wireless communications via a wireless communication system, such as a 3GPP system, such as a 3GPP system supporting one or more of: New Radio (NR) and beyond, Long Term Evolution (LTE), Narrow-band IoT (NB-IoT), and Long Term Evolution-enhanced Machine Type Communication (LTE-M), and 3GPP system operated in licensed bands or unlicensed bands. Furthermore, it is also foreseen to support future 3GPP systems, such as 6G systems.

Processor circuitry 702 is optionally configured to perform any of the operations disclosed in FIGS. 5A-5C (such as any one or more of: S102, S104, S106, S106A, S106B, S106C, S108, S108A, S108B, S108C, S108D, S108D_1, S108D_2, S108D_3, S108D_4, S108E, S108E_1, S108F, S108F_1, S108G, S109, S110, S110A, S110B, S111, S112, S113, S114, S116, S118, S120). The operations of the transmitter node 700 may be embodied in the form of executable logic routines (for example, lines of code, software programs, etc.) that are stored on a non-transitory computer readable medium (for example, memory circuitry 701) and are executed by processor circuitry 702.

Furthermore, the operations of the transmitter node 700 may be considered a method that the transmitter node 700 is configured to carry out. Also, while the described functions and operations may be implemented in software, such functionality may also be carried out via dedicated hardware or firmware, or some combination of hardware, firmware and/or software. Memory circuitry 701 may be one or more of a buffer, a flash memory, a hard drive, a removable media, a volatile memory, a non-volatile memory, a random access memory (RAM), and any other suitable device. In a typical arrangement, memory circuitry 701 may include a non-volatile memory for long term data storage and a volatile memory that functions as system memory for processor circuitry 702. Memory circuitry 701 may exchange data with processor circuitry 702 over a data bus. Control lines and an address bus between memory circuitry 701 and processor circuitry 702 also may be present (not shown in FIG. 8). Memory circuitry 701 is considered a non-transitory computer readable medium.

Memory circuitry 701 may be configured to store a resource configuration, a set of allocated resources, a set of required resources, a second message, a capability message in a part of the memory.

FIG. 9 shows a block diagram of an example receiver node 800 according to the disclosure. The receiver node 800 comprises memory circuitry 801, processor circuitry 802, and a wireless interface 803. The receiver node 800 may be configured to perform any of the methods disclosed in FIGS. 6A-6C. In other words, the receiver node 800 may be configured for supporting reception of a reference signal for positioning in one or more unlicensed frequency bands. In one or more example methods, the receiver node 800 can be one or more of: a wireless device (such as wireless device 300), a receiver wireless device (such as wireless device 300A), a network node (such as network node 400, 400A), a network node assisted by a resource allocation node (such as CN 600).

The receiver node 800 is configured to obtain (such as via the wireless interface 803) a resource configuration indicative of a set of allocated resources comprising a first number of frequency channels.

The receiver node 800 is configured to initiate (such as via the processor circuitry 802) a reception of the reference signal using a set of required resources, wherein the set of required resources is a subset of the set of allocated resources.

The wireless interface 803 is configured for wireless communications via a wireless communication system, such as a 3GPP system, such as a 3GPP system supporting one or more of: New Radio (NR) and beyond, Long Term Evolution (LTE), Narrow-band IoT (NB-IoT), and Long Term Evolution-enhanced Machine Type Communication (LTE-M) and 3GPP system operated in licensed bands or unlicensed bands. Furthermore, it is also foreseen to support future 3GPP systems, such as 6G systems.

Processor circuitry 802 is optionally configured to perform any of the operations disclosed in FIG. 6A-6C (such as any one or more of: S202, S204, S206, S206A, S206B, S207, S208, S208A, S208B, S208C, S208D, S208D_1, S208D_2, S210, S211, S211_1, S212, S214, S215, S216, S218, S220, S220_1, S222, S224, S224A). The operations of the receiver node 800 may be embodied in the form of executable logic routines (for example, lines of code, software programs, etc.) that are stored on a non-transitory computer readable medium (for example, memory circuitry 801) and are executed by processor circuitry 802.

Furthermore, the operations of the receiver node 800 may be considered a method that the receiver node 800 is configured to carry out. Also, while the described functions and operations may be implemented in software, such functionality may also be carried out via dedicated hardware or firmware, or some combination of hardware, firmware and/or software.

Memory circuitry 801 may be one or more of a buffer, a flash memory, a hard drive, a removable media, a volatile memory, a non-volatile memory, a random access memory (RAM), and any other suitable device. In a typical arrangement, memory circuitry 801 may include a non-volatile memory for long term data storage and a volatile memory that functions as system memory for processor circuitry 802. Memory circuitry 801 may exchange data with processor circuitry 802 over a data bus. Control lines and an address bus between memory circuitry 801 and processor circuitry 802 also may be present (not shown in FIG. 9). Memory circuitry 801 is considered a non-transitory computer readable medium.

Memory circuitry 801 may be configured to store a resource configuration, a set of allocated resources, a set of required resources, a reference signal, a part of a reference signal, a first message, a third message in a part of the memory.

FIG. 10 shows a block diagram of an example resource allocation node 900 according to the disclosure. The resource allocation node 900 comprises memory circuitry 901, processor circuitry 902, and a wireless interface 903. The resource allocation node 900 may be configured to perform any of the methods disclosed in FIG. 7. In other words, the resource allocation node 900 may be configured for supporting transmission and/or reception of a reference signal for positioning in one or more unlicensed frequency bands. In one or more examples, a resource allocation node 900 can be one or more of: a network node (such as network node 400, 400A), a network node assisted by an LMF and/or a CN (such as CN 600), a coordinating network node (such as the network node 400, 400A and/or the CN 600), a coordinating network node (such as network node 400, 400A) assisted by an LMF and/or a CN (such as CN 600), a radio network node (such as radio network node 400, 400A), and a wireless device (such as wireless device 300, 300A).

The resource allocation node 900 is configured to communicate with a transmitter node, such as the transmitter node disclosed herein, using a wireless communication system.

The resource allocation node 900 is configured to receive (such as via the wireless interface 903), from a transmitter node, a third message indicative of a length of the reference signal.

The resource allocation node 900 is configured to determine (such as via the processor circuitry 902), based on the third message, a resource configuration indicative of a set of allocated resources comprising a first number of frequency channels. A transmission of the reference signal requires a set of required resources. The set of required resources is a subset of the set of allocated resources.

The resource allocation node 900 is configured to provide (such as via the wireless interface 903) the resource configuration.

The wireless interface 903 is configured for wireless communications via a wireless communication system, such as a 3GPP system, such as a 3GPP system supporting one or more of: New Radio (NR) and beyond, Long Term Evolution (LTE), Narrow-band IoT (NB-IoT), and Long Term Evolution-enhanced Machine Type Communication (LTE-M) and 3GPP system operated in licensed bands or unlicensed bands. Furthermore, it is also foreseen to support future 3GPP systems, such as 6G systems.

The resource allocation node 900 is optionally configured to perform any of the operations disclosed in FIG. 7 (such as any one or more of: S502, S503, S504, S504A, S506, S506A). The operations of the resource allocation node 900 may be embodied in the form of executable logic routines (for example, lines of code, software programs, etc.) that are stored on a non-transitory computer readable medium (for example, memory circuitry 901) and are executed by processor circuitry 902.

Furthermore, the operations of the resource allocation node 900 may be considered a method that the resource allocation node 900 is configured to carry out. Also, while the described functions and operations may be implemented in software, such functionality may also be carried out via dedicated hardware or firmware, or some combination of hardware, firmware and/or software.

Memory circuitry 901 may be one or more of a buffer, a flash memory, a hard drive, a removable media, a volatile memory, a non-volatile memory, a random access memory (RAM), and any other suitable device. In a typical arrangement, memory circuitry 901 may include a non-volatile memory for long term data storage and a volatile memory that functions as system memory for processor circuitry 902. Memory circuitry 901 may exchange data with processor circuitry 902 over a data bus. Control lines and an address bus between memory circuitry 901 and processor circuitry 902 also may be present (not shown in FIG. 10). Memory circuitry 901 is considered a non-transitory computer readable medium.

Memory circuitry 901 may be configured to store a third message, a capability message in a part of the memory.

FIG. 11 shows a signaling diagram of an example communication 1000 between network nodes 400, 400A (such as radio network nodes), a wireless device 300, and a CN 600 according to this disclosure. FIG. 11 shows a DL-based positioning procedure (such as, a Uu-link positioning procedure), in which the network node 400, 400A are configured to transmit, to the wireless device 300, a reference signal for positioning the wireless device 300. The network node 400 may be referred as a transmitter node (such as, transmitter node 700 of FIG. 8), whereas the wireless device 300 may be referred as a receiver node (such as, receiver node 800 of FIG. 9). The network nodes 400A may be referred as assisting transmitter nodes and/or neighboring transmitter nodes, such as nodes participating in the positioning of the wireless device. The network node 400 may be seen as a network node intended to serve the wireless device 300. The CN 600 may be seen as a resource allocation node (such as, resource allocating node 900 of FIG. 10).

In one or more examples, the wireless device 300 transmits, to the network nodes 400, 400A and/or the CN 600, a capability message 1002 indicative of a capability of the wireless device to perform frequency combining of a received reference signal or of parts of the reference signal at one or more time occasions. In one or more examples, the capability message comprises a maximum time span indicative of a time within which frequency combining can be performed. In one or more examples, the capability message may be indicative of a number of frequency channels for transmitting the reference signal. In one or more examples, the capability message may be indicative of the capability of the wireless device 300 to perform positioning measurements based on a reference signal received from a number of frequency channels, such as LBT channels.

In one or more examples, a frequency combining procedure is a procedure to aggregate the received reference signal in multiple frequency channels, such as to aggregate a plurality of parts of the reference signal that are received in respective frequency channels. In one or more examples, the aggregation of the plurality of parts of the reference signal can be performed simultaneously at the same time occasion and/or at different time occasions. In one or more examples, the frequency combining procedure may involve frequency stitching, in which there is a phase correction between two adjacent frequency channels.

In one or more examples, the network nodes 400, 400A transmit, to the CN 600, third messages 1004 indicative of a length of the reference signal. In other words, the third message may be indicative of a number of frequency channels required to transmit the reference signal. For example, the third message may be seen as a configuration of the reference signal including the length of the reference signal.

The CN 600 collects and determines 1005, based on one or more of the third messages 1004 and the capability message 1002, a resource configuration 1006 indicative of a set of allocated resources comprising a number of frequency channels. In one or more examples, the network nodes 400, 400A have access to the resource configuration 1006 determined by the CN 600 since the network nodes 400, 400A can be seen as network nodes assisted by the CN 600. In one or more examples, the network nodes 400, 400A can obtain the resource configuration 1006 from the CN 600.

The CN 600 transmits, to the wireless device 300, the resource configuration 1006. The wireless device 300 may obtain the resource configuration 1006 from the CN 600 via the network node 400, such as a network node serving the wireless device.

The CN 600 may transmit, to the wireless device 300, a positioning measurement request 1008 indicative of a request to perform a positioning measurement. The positioning measurement request may inform the wireless device 300 about a reception of a reference signal for position, such as a periodic reception of the reference signal.

The network nodes 400, 400A initiate 1009A, 1009B a transmission of a reference signal 1010 using a set of required resources. For example, in case of aperiodic reference signal transmission, the CN 600 can trigger the network node 400, 400A to transmit the reference signal according to the resource configuration 1006. The set of required resources is a subset of the set of allocated resources. In other words, the network nodes 400, 400A may require less resources (such as the set of required resources) than the ones (such as the set of allocated resources) provided by the CN 600.

In one or more examples, the network nodes 400, 400A initiate 1009A, 1009B a transmission of the reference signal 1010 by determining an availability of the number of frequency channels. In one or more examples, the network nodes 400, 400A determine an availability of the number of frequency channels by performing an LBT procedure (such as, a CCA) on the number of frequency channels. For example, the network nodes 400, 400A may perform a wideband LBT procedure, such as an LBT procedure on M frequency channels in which only N frequency channels are used for transmission, with N<M. In one or more examples, the network nodes 400, 400A determine, based on the LBT procedure, a set of available frequency channels to be used for transmission of the reference signal.

In one or more examples, the network nodes 400, 400A transmit, to the wireless device 300, the reference signal 1010 or part of the reference signal 1010 for positioning of the wireless device 300 using the set of available frequency channels. Put differently, the network nodes 400, 400A perform a transmission of the reference signal 1010 or part of the reference signal 1010 based on the LBT procedure outcome, such as based on whether the set of frequency channels are available or not to be used for such transmission.

In one or more examples, the wireless device 300 receives the reference signal 1010 by performing a blind detection procedure on the number of frequency channels, such as on each frequency channel. The wireless device may detect a reception power level on each of the frequency channels and determine whether the reception power level satisfies a reception criterion. In one or more examples, the wireless device 300 performs reception of the reference signal 1010 or a part of the reference signal 1010 based on the blind detection procedure outcome, such as based on whether the reception power level is higher than a certain reception threshold. For example, upon determining that the reception power level satisfies the reception criterion, the wireless device 300 determines a successful reception of the reference signal 1010 or a part of the reference signal 1010 on one or more of the number of frequency channels.

In one or more examples, the wireless device 300 can process 1012 all parts of the reference signal 1010 together, such as when the reference signal 1010 is transmitted using contiguous frequency channels. In one or more examples, the wireless device 300 can process 1012 a number of parts of the reference signal 1010 together, such as when a part of the reference signal 1010 is transmitted using contiguous frequency channels.

In one or more examples, the wireless device 300 can process 1012 the reference signal 1010 by applying a frequency combining procedure to a plurality of parts of the reference signal 1010, with a part of the reference signal 1010 being received on a frequency channel of the set of frequency channels. In other words, the wireless device may combine the plurality of parts of the reference signal 1010 so that the reference signal 1010 can be reconstructed or partially reconstructed.

In one or more examples, the wireless device 300 may perform 1012, based on the reconstructed reference signal, positioning measurements 1014. A positioning measurement can be one or more of: a timing measurement (such as, a Time difference of arrival (TDOA) and/or a Round-trip Time (RTT)), a received signal strength (RSRP), and an angle measurement (such as, an angle of departure (AoD) and/or an angle or arrival (AoA)).

In one or more examples, the wireless device 300 transmits, to a calculating node, the positioning measurements 1014. In one or more examples, the wireless device 300 can provide a single positioning measurement comprising positioning measurements associated with the one or more frequency channels used to receive the plurality of parts of the reference signal, such as when the plurality of parts of the reference signal are received on contiguous frequency channels. In one or more examples, the wireless device 300 can provide multiple positioning measurements, each positioning measurement associated with the one or more frequency channels used to receive the plurality of parts of the reference signal, such as when the plurality of parts of the reference signal are received on non-contiguous frequency channels.

The calculating node may be one or more of: the CN 600, and a network node assisted by the CN 600 (such as network node 400). In the embodiment of FIG. 11, the calculating node is the CN 600. The calculating node may determine 1016, based on the positioning measurement 1014, the position of the wireless device 300 and report the determined position to the wireless device 300.

The present disclosure may involve an UL-based positioning procedure (not shown in FIG. 11). In an UL-based positioning procedure, the wireless device 300 may be referred as a transmitter node, whereas the network node 400, 400A may be referred as a receiver node. An UL-based positioning procedure may differ from the DL-based positioning procedure illustrated in FIG. 11 in that the wireless device 300 may be configured to transmit, to the network nodes 400, 400A, a reference signal for positioning the wireless device 300. In one or more examples, the wireless device 300 is served by the network node 400. The wireless device 300 may obtain, from the network node 400, a resource configuration indicative of a set of allocated resources comprising a number of frequency channels. The network node may inform the CN node 600 (such as, the LMF) on the resource configuration. The CN node 600 may transmit, to the network nodes 400B, the resource configuration. The CN node 600 may inform the network node 400B on how to measure the reference signal for positioning to be received from the wireless device 300. The wireless device 300 may perform an LBT procedure (such as, a CCA) on the number of frequency channels. In one or more examples, the wireless device 300 determines, based on the LBT procedure, a set of available frequency channels to be used for transmission of the reference signal. In one or more examples, the wireless device 300 performs a transmission of the reference signal or part of the reference signal based on the LBT procedure outcome, such as based on whether the set of frequency channels are available or not to be used for such transmission. The network nodes 400, 400A may perform, based on the reference signal, positioning measurements and share the positioning measurements with a calculating node. The calculating node may determine, based on the positioning measurements, the position of the wireless device 300 and report the determined position to the wireless device 300.

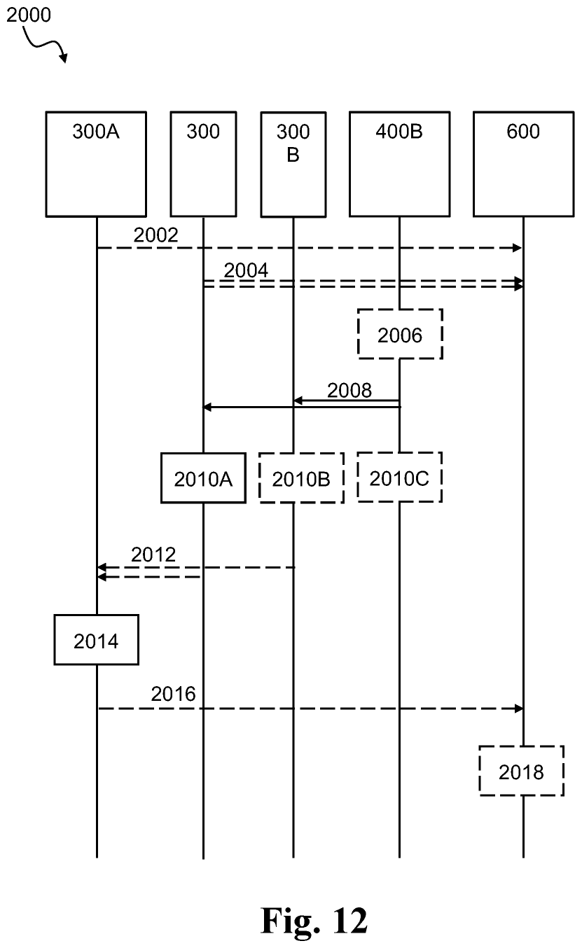

FIG. 12 shows a signaling diagram of an example communication between a coordinating network node 400B, wireless devices 300, 300A, 300B, and a CN 600 according to this disclosure. FIG. 12 shows an SL-based positioning procedure (such as, a PC5-link positioning procedure), in which the wireless devices 300, 300B are configured to transmit, to the wireless device 300A, a reference signal for positioning the wireless device 300. The wireless devices 300, 300B may be referred as transmitter nodes (such as, transmitter node 700 of FIG. 8), such as transmitter wireless devices and/or first wireless devices, whereas the wireless device 300A may be referred as a receiver node (such as, receiver node 800 of FIG. 9), such as a receiver wireless device. The wireless devices 300B may be referred to as assisting transmitter nodes and/or neighboring transmitter nodes, such as nodes participating in the positioning of the wireless device 300A. The network node 400B may be seen as a coordinating network node, such as a network node configured to provide resource configurations to the wireless devices 300, 300B to be used for transmission of the reference signal. The network node 400B may be seen as a resource allocation node (such as, resource allocating node 900 of FIG. 10).

In one or more examples, the wireless device 300A transmits, to the network node 400B and/or the CN 600, a capability message 2002 indicative of a capability of the wireless device 300A to perform frequency combining of a received reference signal or of parts of the reference signal at one or more time occasions. In one or more examples, the capability message comprises a maximum time span indicative of a time within which frequency combining can be performed. In one or more examples, the capability message 2004 is similar to capability message 1002 of FIG. 11. In one or more examples, when the network node 400B serves the wireless devices 300, 300B, the capability message 2002 can be transmitted to the network node 400B. In one or more examples, when the network node 400B does not serve the wireless devices 300, 300B, the capability message 2002 can be transmitted to the network node 400B via network nodes intended to serve the wireless devices 300, 300B.

In one or more examples, the wireless devices 300, 300B transmit, to the network node 400B and/or to the CN 600, third messages 2004 indicative of a length of the reference signal. In other words, the third message may be indicative of a number of frequency channels required to transmit the reference signal. In one or more examples, the wireless devices 300, 300B transmit the third message 2004 to the CN 600 via the network node 400B (such as, a coordinating network node) and/or respective network nodes intended to serve the wireless devices 300, 300B.

The network node 400B may determine 2006, based on one or more of the third messages 2004 and the capability message 2002, a resource configuration 2008 indicative of a set of allocated resources comprising a number of frequency channels.

The network node 400B transmits, to the wireless devices 300, 300B, the resource configuration 2008, the resource configuration indicative of a number of frequency channels to be used for transmission of the reference signal 2012. The wireless devices 300, 300B may obtain the resource configuration 2008 from a network node 400B.

The wireless devices 300, 300B initiate 2010A, 2010B a transmission of a reference signal 2012 using a set of required resources. The set of required resources is a subset of the set of allocated resources. In other words, the wireless devices 300, 300B may require less resources (such as the set of required resources) than the ones (such as the set of allocated resources) provided by the network node 400B.

In one or more examples, the wireless devices 300, 300B initiate 2010A, 2010B a transmission of a reference signal 2012 by determining an availability of the number of frequency channels.

In one or more examples, the network node 400B assists 2010C in the transmission initiations 2010A, 2010B of the wireless devices 300, 300B.

In one or more examples, the network node 400B may perform a first LBT procedure (such as, a first CCA) on the number of frequency channels. For example, the network node 400B may perform a wideband LBT procedure, such as an LBT procedure on M frequency channels in which only N frequency channels are used for transmission, with N ≤M. In one or more examples, the network node 400B determines, based on the first LBT procedure, a set of available frequency channels to be used for transmission of the reference signal 2012 by the wireless devices 300, 300B.

In one or more examples, the network node 400B assigns and/or activates the set of available frequency channels to be used by the wireless devices 300, 300B. The network node may transmit, to the wireless devices 300, 300B, a message informing the wireless devices 300, 300B about the set of available frequency channels. The wireless devices 300, 300B may also perform a second LBT procedure (such as, a first CCA) on the number of frequency channels and/or on the set of available frequency channels prior to the transmission of the reference signal.

Optionally, the network node 400B is the only node performing the first LBT procedure (such as, a first CCA) on the number of frequency channels. In one or more examples, the network node 400B assigns and/or activates the set of available frequency channels to be used by the wireless devices 300, 300B. The network node may transmit, to the wireless devices 300, 300B, a message informing the wireless devices 300, 300B about the set of available frequency channels. The wireless devices may transmit the reference signal 2012 immediately (such as within COT).

Optionally, the network node 400B does not perform the first LBT procedure (such as, a first CCA) on the number of frequency channels. In one or more examples, the network node 400B assigns and/or activates the number of frequency channels based on the resource configuration 2008. In one or more examples, the wireless devices 300, 300B perform a second LBT procedure (such as, a first CCA) on the number of frequency channels. In one or more examples, the wireless devices 300, 300B determines, based on the second LBT procedure, a set of available frequency channels to be used for transmission of the reference signal 2012 by the wireless devices 300, 300B.

In one or more examples, the wireless devices 300, 300B transmit, to the wireless device 300A, the reference signal 2012 or part of the reference signal 2012 for positioning of the wireless device 300A using the set of available frequency channels. Put differently, the wireless devices 300, 300B perform a transmission of the reference signal 2012 or part of the reference signal 2012 based on the LBT procedure outcome, such as based on whether the set of frequency channels are available or not to be used for such transmission.

In one or more examples, the wireless device 300A receives the reference signal 2012 by performing a blind detection procedure on the number of frequency channels, such as on each frequency channel. The wireless device 300A may detect a reception power level on each of the frequency channels and determine whether the reception power level satisfies a reception criterion. In one or more examples, the wireless device 300A performs reception of the reference signal 2012 or a part of the reference signal 2012 based on the blind detection procedure outcome, such as based on whether the reception power level is higher than a certain reception threshold. For example, upon determining that the reception power level satisfies the reception criterion, the wireless device 300A determines a successful reception of the reference signal 2012 or a part of the reference signal 2012 on one or more of the number of frequency channels.

In one or more examples, the wireless device 300A can process 2014 all parts of the reference signal 2012 together, such as when the reference signal 2012 is transmitted using contiguous frequency channels. In one or more examples, the wireless device 300A can process 2014 a number of parts of the reference signal 2012 together, such as when a part of the reference signal 2012 is transmitted using contiguous frequency channels.

In one or more examples, the wireless device 300A can process 2014 the reference signal 2012 by applying a frequency combining procedure to a plurality of parts of the reference signal 2012, with a part of the reference signal 212 being received on a frequency channel of the set of frequency channels. In other words, the wireless device 300A may combine the plurality of parts of the reference signal 2012 so that the reference signal 2012 can be reconstructed or partially reconstructed.

In one or more examples, the wireless device 300A may perform 2014, based on the reconstructed reference signal, positioning measurements 2016. The positioning measurements 2016 may be similar to positioning measurements 1014 of FIG. 11. In one or more examples, the wireless device 300A transmits, to a calculating node, the positioning measurements 2016.

The calculating node may be one or more of: the CN 600, and a network node assisted by the CN 600 (such as, network node 400B). In the embodiment of FIG. 12, the calculating node is CN 600. The calculating node may determine 2018, based on the positioning measurement 2016, the position of the wireless device 300A and report the determined position to the wireless device 300A.

Examples of methods and products (transmitter node, receiver node, and resource allocation node) according to the disclosure are set out in the following items:

Item 1. A method, performed by a transmitter node, for supporting transmission of a reference signal for positioning in one or more unlicensed frequency bands, wherein the method comprises:
obtaining (S106) a resource configuration indicative of a set of allocated resources comprising a first number of frequency channels; and
initiating (S108) a transmission of the reference signal using a set of required resources, wherein the set of required resources is a subset of the set of allocated resources.

Item 2. The method according to item 1, wherein the set of required resources comprises a second number of frequency channels, wherein the first number of frequency channels is greater than the second number of frequency channels, and wherein initiating (S108) a transmission of the reference signal comprises initiating (S108A) a transmission of the reference signal using the second number of frequency channels among the first number of frequency channels.

Item 3. The method according to any of the previous items, wherein the set of allocated resources comprises a first number of time occasions and the set of required resources comprises a second number of time occasions, wherein the first number of time occasions is greater than or equal to the second number of time occasions, and wherein initiating (S108) a transmission of the reference signal comprises initiating (S108B) a transmission of the reference signal using the second number of time occasions among the first number of time occasions.

Item 4. The method according to any of the previous items, wherein the set of allocated resources comprises a first number of time-frequency resources and the set of required resources comprises a second number of time-frequency resources, wherein the first number of time-frequency resources is greater than the second number of time-frequency resources, and wherein initiating (S108) a transmission of the reference signal comprises initiating (S108C) a transmission of the reference signal using the second number of time-frequency resources among the first number of time-frequency resources.

Item 5. The method according to any of the previous items, wherein initiating (S108) a transmission comprises determining (S108D) an availability of the first number of frequency channels at a first time occasion.

Item 6. The method according to item 5, wherein determining (S108D) an availability of the first number of frequency channels comprises performing (S108D_1) a first Listen Before Talk (LBT) procedure on the first number of frequency channels and determining (S108D_2), based on the first Listen Before Talk (LBT) procedure, a first set of available frequency channels at the first time occasion.

Item 7. The method according to item 6, wherein initiating (S108) a transmission comprises transmitting (S108E) the reference signal or a first part of the reference signal using the first set of available frequency channels at the first time occasion.

Item 8. The method according to any of items 6-7, wherein determining (S108D) an availability of the first number of frequency channels comprises detecting (S108D_3) a first Listen Before Talk (LBT) failure and determining (S108D_4), based on the first Listen Before Talk (LBT) failure, a first set of unavailable frequency channels at the first time occasion.

Item 9. The method according to any of items 7-8, wherein when the first part has been transmitted, the method comprises determining (S110) an availability of the first set of unavailable frequency channels at a second time occasion by performing (S110A) a second Listen Before Talk (LBT) procedure on the first set of unavailable frequency channels, and determining (S110B), based on the second Listen Before Talk (LBT) procedure, a second set of available frequency channels at the second time occasion.

Item 10. The method according to item 9, wherein initiating (S108) a transmission comprises transmitting (S108F) a second part or remaining part of the reference signal using the second set of available frequency channels at the second time occasion.

Item 11. The method according to any of items 7-10, wherein the method comprises determining (S112) whether the transmission of the reference signal was successful.

Item 12. The method according to item 11, wherein in accordance with the transmission of the reference signal not being successful, the method comprises transmitting (S114), to the receiver node, a first message indicative of the failure in the transmission of the reference signal or a part of the reference signal.

Item 13. The method according to any of the previous items, wherein the method comprises receiving (S116), from the receiver node, a second message indicative of a reception failure of the reference signal or a part of the reference signal.

Item 14. The method according to item 13, wherein the second message is indicative of an unsatisfactory positioning measurement performed by the receiver node based on the reference signal.

Item 15. The method according to any of items 13-14, wherein the method comprises performing (S118), based on the second message or in accordance with the transmission of the reference signal not being successful, a retransmission of the reference signal or a part of the reference signal to the receiver node.

Item 16. The method according to any of items 7-15, wherein transmitting (S108E) the reference signal or the first part, or transmitting (S108F) the second part of the reference signal comprises transmitting (S108E_1, S108F_1) using one or more of: contiguous frequency channels associated with one or more time occasions, and non-contiguous frequency channels associated with one or more time occasions.

Item 17. The method according to any of items 7-16, wherein initiating (S108) a transmission comprises determining (S108G) whether a transmission of the reference signal or part of the reference signal satisfies a stop criterion, and in accordance with the transmission satisfying the stop criterion, the method comprises stopping (S109) retransmitting the reference signal or part of the reference signal.

Item 18. The method according to item 17, wherein the stop criterion is based on one or more of: a length of the reference signal and a channel occupancy time (COT) length.

Item 19. The method according to any of the previous items, wherein the method comprises receiving (S102) from, the receiver node, a capability message indicative of a capability of the receiver node to perform frequency combining of a received reference signal or of parts of the reference signal at one or more time occasions.

Item 20. The method according to item 19, wherein the capability message comprises a maximum time span indicative of a time within which frequency combining can be performed.

Item 21. The method according to any of the previous items, wherein the method comprises transmitting (S104), to the receiver node, a third message indicative of a length of the reference signal.

Item 22. The method according to any of the previous items, wherein obtaining (S106) the resource configuration comprises obtaining (S106A) the resource configuration from a resource allocation node via the receiver node.

Item 23. The method according to any of the previous items, wherein obtaining (S106) the resource configuration comprises obtaining (S106B) the resource configuration from a resource allocation node via a coordinating network node.

Item 24. The method according to any of the previous items, wherein the resource configuration is based on one or more of: the capability message and the third message.

Item 25. The method according to any of the previous items, wherein obtaining (S106) the resource configuration comprises determining (S106C) the resource configuration at the transmitter node.

Item 26. The method according to any of the previous items, the method comprising transmitting (S120) the resource configuration to the receiving node.

Item 27. The method according to any of the previous items, wherein the transmitter node is a wireless device and/or a network node.

Item 28. A method, performed by a receiver node, for supporting reception of a reference signal for positioning in one or more unlicensed frequency bands, wherein the method comprising:
obtaining (S206) a resource configuration indicative of a set of allocated resources comprising a first number of frequency channels; and
initiating (S208) a reception of the reference signal using a set of required resources, wherein the set of required resources is a subset of the set of allocated resources.

Item 29. The method according to item 28, wherein the set of required resources comprises a second number of frequency channels, wherein the first number of frequency channels is greater than the second number of frequency channels, and wherein initiating (S208) a reception of the reference signal comprises initiating (S208A) a reception of the reference signal using the second number of frequency channels among the first number of frequency channels.

Item 30. The method according to any of items 28-29, wherein the set of allocated resources comprises a first number of time occasions and the set of required resources comprises a second number of time occasions, wherein the first number of time occasions is greater than the second number of time occasions, and wherein initiating (S208) a reception of the reference signal comprises initiating (S208B) a reception of the reference signal using the second number of time occasions among the first number of time occasions.

Item 31. The method according to any of items 28-30, wherein the set of allocated resources comprises a first number of time-frequency resources and the set of required resources comprises a second number of time-frequency resources, wherein the first number of time-frequency resources is greater than the second number of time-frequency resources, and wherein initiating (S208) a reception of the reference signal comprises initiating (S208C) a reception of the reference signal using the second number of time-frequency resources among the first number of time-frequency resources.

Item 32. The method according to any of the previous items, wherein initiating (S208) a reception comprises performing (S208D) a blind detection procedure on the first number of frequency channels.

Item 33. The method according to item 32, wherein performing (S208D) a blind detection procedure comprises detecting (S208D_1) a reception power level on the first number of frequency channels, and determining (S208D_2) whether the reception power level satisfies a reception criterion.

Item 34. The method according to item 33, wherein in accordance with the reception power level satisfying the reception criterion, the method comprises determining (S210) a successful reception of the reference signal or a part of the reference signal on one or more of the first number of frequency channels.

Item 35. The method according to any of items 28-34, wherein the method comprises receiving (S211) the reference signal or a first part of the reference signal using a first set of available frequency channels at a first time occasion.

Item 36. The method according to any of items 28-35, wherein the method comprises determining (S215) an unsatisfactory positioning measurement based on the reference signal or a part of the reference signal.

Item 37. The method according to any of items 33-36, wherein in accordance with the reception power level not satisfying the reception criterion, the method comprises determining (S212) a failure in the reception of the reference signal or a part of the reference signal on one or more of the first number of frequency channels.

Item 38. The method according to item 37, wherein in accordance with the determination (S212) of a failure in the reception of the reference signal or part of the reference signal, the method comprises transmitting (S214), to the transmitter node, a second message indicative of a reception failure of the reference signal or a part of the reference signal.

Item 39. The method according to any of items 36-38, wherein the method comprises performing (S216), in accordance with the determination of a failure in the reception of the reference signal or a part of the reference signal, or in accordance with the determination of an unsatisfactory positioning measurement, an additional reception of the reference signal or a part of the reference signal from the transmitter node.

Item 40. The method according to any of items 36-39, wherein the method comprises performing (S218) an additional blind detection procedure on the first number of frequency channels.

Item 41. The method according to item 40, wherein the method comprises receiving (S220) a second part or remaining part of the reference signal using a second set of available frequency channels at a second time occasion.

Item 42. The method according to any of items 28-41, wherein the method comprises receiving (S222), from the transmitter node, a first message indicative of the failure in the transmission of the reference signal or a part of the reference signal.

Item 43. The method according to any of items 35-42, wherein receiving (S211) the reference signal or the first part, or receiving (S220) the second part of the reference signal comprises receiving (S211_1, S220_1) using one or more of: contiguous frequency channels associated with one or more time occasions, and non-contiguous frequency channels associated with one or more time occasions.

Item 44. The method according to any of items 35-43, wherein the method comprises processing (S224) the received reference signal.

Item 45. The method according to any of items 28-44, wherein the method comprises transmitting (S202), to the transmitter node, a capability message indicative of a capability of the receiver node to perform frequency combining of a received reference signal or of parts of the reference signal at one or more time occasions.

Item 46. The method according to item 45, wherein processing (S224) the received reference signal comprises applying (S224A) a frequency combining procedure to the first part of the reference signal, the second part of the reference signal, and/or a remaining part of the reference signal.

Item 47. The method according to any of items 45-46, wherein the capability message comprises a maximum time span indicative of a time within which frequency combining can be performed.

Item 48. The method according to any of items 28-47, wherein the method comprises receiving (S204), from the transmitter node, a third message indicative of a length of the reference signal.

Item 49. The method according to any of items 28-48, wherein obtaining (S206) the resource configuration comprises obtaining (S206A) the resource configuration from a resource allocation node.

Item 50. The method according to item 49, wherein the method comprises transmitting (S207) the resource configuration to the transmitter node.

Item 51. The method according to any of items 28-50, wherein obtaining (S206) the resource configuration comprises obtaining (S206B) the resource configuration from a resource allocation node via one or more of: the transmitter node or a coordinating network node.

Item 52. The method according to any of items 28-51, wherein the resource configuration is based on one or more of: the capability message and the third message.

Item 53. The method according to any of items 28-52, wherein the receiving node is a wireless device and/or a network node.

Item 54. A method, performed by a resource allocation node, for supporting transmission and/or reception of a reference signal for positioning in one or more unlicensed frequency bands, the method comprising:
receiving (S502), from a transmitter node, a third message indicative of a length of the reference signal;
determining (S504), based on the third message, a resource configuration indicative of a set of allocated resources comprising a first number of frequency channels, wherein a transmission of the reference signal requires a set of required resources and wherein the set of required resources is a subset of the set of allocated resources; and
providing (S506) the resource configuration.

Item 55. The method according to item 54, wherein providing (S506) the resource configuration comprises providing (S506A) the resource configuration to one or more of: a transmitter node, a receiver node, and a coordinating network node.

Item 56. The method according to any of items 54-55, wherein the method comprises receiving (S503), from the receiver node, a capability message indicative of a capability of the receiver node to perform frequency combining of a received reference signal or of parts of the reference signal at one or more time occasions, and wherein determining (S504) a resource configuration comprises determining (S504A) a resource configuration based on the capability message.

Item 57. The method according to item 56, wherein the capability message comprises a maximum time span indicative of a time within which frequency combining can be performed.

Item 58. A transmitter node comprising memory circuitry, processor circuitry, and a wireless interface, wherein the transmitter node is configured to perform any of the methods according to any of items 1-27.

Item 59. A receiver node comprising memory circuitry, processor circuitry, and a wireless interface, wherein the receiver node is configured to perform any of the methods according to any of items 28-53.

Item 60. A resource allocation node comprising memory circuitry, processor circuitry, and a wireless interface, wherein the resource allocation node is configured to perform any of the methods according to any of items 54-57.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that the figures comprise some circuitries or operations which are illustrated with a solid line and some circuitries, components, features, or operations which are illustrated with a dashed line. Circuitries or operations which are comprised in a solid line are circuitries, components, features, or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed. It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes, and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a transmitter node, for supporting transmission of a reference signal for positioning in one or more unlicensed frequency bands, wherein the method comprises:
obtaining a resource configuration indicative of a set of allocated resources comprising a first number of frequency channels; and
initiating a transmission of the reference signal using a set of required resources, wherein the set of required resources is a subset of the set of allocated resources.

2. The method according to claim 1, wherein the set of required resources comprises a second number of frequency channels, wherein the first number of frequency channels is greater than the second number of frequency channels, and wherein initiating a transmission of the reference signal comprises initiating a transmission of the reference signal using the second number of frequency channels among the first number of frequency channels.

3. The method according to claim 1, wherein the set of allocated resources comprises a first number of time occasions and the set of required resources comprises a second number of time occasions, wherein the first number of time occasions is greater than or equal to the second number of time occasions, and wherein initiating a transmission of the reference signal comprises initiating a transmission of the reference signal using the second number of time occasions among the first number of time occasions.

4. The method according to claim 1, wherein the set of allocated resources comprises a first number of time-frequency resources and the set of required resources comprises a second number of time-frequency resources, wherein the first number of time-frequency resources is greater than the second number of time-frequency resources, and wherein initiating a transmission of the reference signal comprises initiating a transmission of the reference signal using the second number of time-frequency resources among the first number of time-frequency resources.

5. (canceled)

6. The method according to claim 3, wherein determining an availability of the first number of frequency channels comprises performing a first Listen Before Talk (LBT), procedure on the first number of frequency channels and determining, based on the first LBT procedure, a first set of available frequency channels at the first time occasion.

7. The method according to claim 4, wherein initiating a transmission comprises transmitting the reference signal or a first part of the reference signal using the first set of available frequency channels at the first time occasion.

8. The method according to claim 6, wherein determining an availability of the first number of frequency channels comprises detecting a first Listen Before Talk (LBT) failure and determining based on the first Listen Before Talk (LBT) failure, a first set of unavailable frequency channels at the first time occasion.

9. The method according to claim 7, wherein when the first part has been transmitted, the method comprises determining an availability of the first set of unavailable frequency channels at a second time occasion by performing a second Listen Before Talk (LBT) procedure on the first set of unavailable frequency channels, and determining, based on the second Listen Before Talk (LBT) procedure, a second set of available frequency channels at the second time occasion.

10. The method according to claim 9, wherein initiating a transmission comprises transmitting a second part or remaining part of the reference signal using the second set of available frequency channels at the second time occasion.

11. The method according to claim 7, wherein the method comprises determining whether the transmission of the reference signal was successful.

12. The method according to claim 11, wherein in accordance with the transmission of the reference signal not being successful, the method comprises transmitting, to the receiver node, a first message indicative of the failure in the transmission of the reference signal or a part of the reference signal.

13. The method according to claim 1, wherein the method comprises receiving, from the receiver node, a second message indicative of a reception failure of the reference signal or a part of the reference signal.

14. The method according to claim 13, wherein the second message is indicative of an unsatisfactory positioning measurement performed by the receiver node based on the reference signal.

15. The method according to claim 13, wherein the method comprises performing, based on the second message or in accordance with the transmission of the reference signal not being successful, a retransmission of the reference signal or a part of the reference signal to the receiver node.

16. The method according to claim 7, wherein transmitting the reference signal or the first part, or transmitting the second part of the reference signal comprises transmitting using one or more of: contiguous frequency channels associated with one or more time occasions, and non-contiguous frequency channels associated with one or more time occasions.

17. The method according to claim 7, wherein initiating a transmission comprises determining whether a transmission of the reference signal or part of the reference signal satisfies a stop criterion, and in accordance with the transmission satisfying the stop criterion, the method comprises stopping retransmitting the reference signal or part of the reference signal.

18. The method according to claim 17, wherein the stop criterion is based on one or more of: a length of the reference signal and a channel occupancy time length.

19. The method according to claim 1, wherein the method comprises receiving from, the receiver node, a capability message indicative of a capability of the receiver node to perform frequency combining of a received reference signal or of parts of the reference signal at one or more time occasions.

20. The method according to claim 19, wherein the capability message comprises a maximum time span indicative of a time within which frequency combining can be performed.

21-27. (canceled)

28. A method, performed by a receiver node, for supporting reception of a reference signal for positioning in one or more unlicensed frequency bands, wherein the method comprising:
obtaining a resource configuration indicative of a set of allocated resources comprising a first number of frequency channels; and
initiating a reception of the reference signal using a set of required resources, wherein the set of required resources is a subset of the set of allocated resources.

29-60. (canceled)
